(19) United States
(12) Patent Application Publication
(10) Pub. No.: US 2011/0006922 A1
(43) Pub. Date: Jan. 13, 2011

(54) BUS LOCATION INDICATING METHOD, BUS VIDEO ACQUIRING METHOD, INTERSECTION VIDEO ACQUIRING METHOD AND VIDEO DELIVERY

(75) Inventors: Tsutomu TSUBOI, Kanagawa (JP); Izuru YAMADA, Yokohama (JP); Hitoshi HARADA, Yokohama (JP)

Correspondence Address: MILES & STOCKBRIDGE PC, 1751 PINNACLE DRIVE, SUITE 500, MCLEAN, VA, 22102-3833, US

(73) Assignee: RENESAS ELECTRONICS CORPORATION

(21) Appl. No.: 12/830,387

(22) Filed: Jul. 5, 2010

(30) Foreign Application Priority Data
Jul. 8, 2009 (JP) 2009-161443

(51) Int. Cl. G08G 1/123; H04N 7/18

(52) U.S. Cl. 340/994; 725/75

(57) ABSTRACT

The present invention provides a method for detecting the current location of a bus at lower cost without using a wideband wireless communication device and displaying it on each bus stop. A center system of a center and each of bus stop systems are coupled to each other via Internet. A roadside wireless unit of the bus stop system contained in the bus stop periodically outputs a beacon containing a bus stop ID to a route bus system equipped on a route bus. The route bus system outputs an ID notification signal including a bus stop ID and a bus ID to the bus stop system. The center system of the center updates location information using the bus stop ID and the bus ID and transmits bus location update data to a suitable target. The bus stop system displays a bus location thereon using the transmitted bus location update data.

### CROSS-REFERENCE TO RELATED APPLICATIONS

The disclosure of Japanese Patent Application No. 2009-161443 filed on Jul. 8, 2009 including the specification, drawings and abstract is incorporated herein by reference in its entirety.

### BACKGROUND OF THE INVENTION

The present invention relates to an operation management system such as a public transport system having a routine-run route, and particularly to a bus location system.

There exist a number of methods each used for detecting the current location of a bus and displaying it on a bus stop.

Japanese Unexamined Patent Publication No. 2006-277126 (patent document 1) discloses the following technology.

In each route bus, a reader regularly transmits a radio wave of a read signal. When the route bus approaches each bus stop, a transponder transmits a radio wave of a response signal containing an identification code specified to the transponder. A communication control device transmits the inherent identification code of transponder to a server via a wideband wireless communication device. At the server, an information acquisition unit refers to a stop management file on the basis of the inherent identification code of transponders that sequentially arrive from the route buses, thereby specifying the corresponding stop, i.e., a stop that the corresponding route bus approaches. A use delivery unit offers those information to a terminal.

Japanese Unexamined Patent Publication No. 2005-84729 (patent document 2) discloses the following technology.

A bus operation status notification system thereof comprises a bus operation status calculating means for calculating bus operation statuses every route/bus stop, based on locations of buses at respective times and identification information about the respective buses, readable recording media (barcodes, for example) indicative of bus stop identification information about the respective bus stops and route identification information about the respective routes along which the buses pass through the bus stops, and a transmitting means for, if the bus stop identification information and route identification information read from the readable recording medium are received thereby, transmitting a bus operation status corresponding to the bus stop and route represented by the received bus stop identification information and route identification information to the transmission source of the bus stop identification information and the route identification information.

### SUMMARY OF THE INVENTION

The technology described in the patent document 1 is, however, not capable of avoiding an increase in cost because the wideband wireless communication device is used.

In the technology described in the patent document 2, an operation status is assumed to be outputted to a display unit of a cellular phone. The present technology is different from the above in terms of the “method for detecting the current location of each bus and displaying it on the bus stop”.

An object of the present invention is to provide a method for detecting the current location of each bus at low cost by a narrow-band communication system in which a communicable range is a radius of a few hundred meters or so, without using a wideband wireless communication device and displaying it on the corresponding bus stop.

Another object of the present invention is to provide a method for transmitting video acquired on a bus to a center by a reliable method at low cost through the above narrow-band communication system.

A further object of the present invention is to provide a method for sending video acquired at a bus stop or an intersection to a bus through the above narrow-band communication system.

Yet another object of the present invention is to provide a method for sending video from a center to a bus through the above narrow-band communication system.

The above, other objects and novel features of the present invention will become apparent from the description of the present specification and the accompanying drawings.

A summary of representative ones of the inventions disclosed in the present application will be explained in brief as follows:

A bus location indicating method according to a typical embodiment of the present invention is related to a traffic system comprising a route bus system installed in each of route buses, a bus stop system having a display part, and a center system coupled to the bus stop system via a network. The bus location indicating method comprises the steps of: allowing the bus stop system to periodically output a bus stop ID notification signal; allowing the route bus system to receive the bus stop ID notification signal and allowing the route bus system to output a bus ID notification signal to the bus stop system; allowing the bus stop system to output a bus system coupling notification signal added with a bus ID and a bus stop ID to the center system; generating bus location update data using the bus ID and the bus stop ID; determining a transmission destination for the bus location update data using the bus ID; allowing the center system to transmit the bus location update data to the transmission destination determined at the transmission destination determining step; and allowing the bus stop system to display location information of the route bus having the route bus system over the display part using the bus location update data.

A bus location indicating method according to another typical embodiment of the present invention is related to a traffic system comprising a route bus system installed in each of route buses, a bus stop system having a display part, and a center system coupled to the bus stop system via a network. The bus location indicating method comprises the steps of: allowing the bus stop system to periodically output a bus stop ID notification signal; allowing the route bus system to receive the bus stop ID notification signal and allowing the route bus system to output a bus ID notification signal added with both a bus ID added to the bus stop ID notification signal and a bus stop ID allocated to the bus stop system to the bus stop system; receiving the bus ID notification signal outputted at the bus ID notification signal output step to thereby start a timer; allowing the bus stop system to output a bus system coupling release notification signal added with the bus ID and the bus stop ID allocated to the bus stop system when a count of the timer is expired; allowing the center system to generate bus location update data using the bus stop ID and the bus ID added to the bus system coupling release notification signal; allowing the center system to determine a transmission destination for the bus location update data using the bus ID; allowing the center system to transmit the bus location update data to the transmission destination determined at the transmission destination determining step; and allowing the bus stop system to display location information of the route bus having the route bus system over the display part using the bus location update data.

A bus video acquiring method according to a further typical embodiment of the present invention is related to a traffic system comprising a route bus system installed in each of route buses, a bus stop system, and a center system having a display part and coupled to the bus stop system via a network. The route bus system has an imaging device for acquiring video. The bus video acquiring method comprises the steps of: allowing the bus stop system to periodically output a bus stop ID notification signal; allowing the route bus system to receive the bus stop ID notification signal and allowing the route bus system to output a bus ID notification signal to the bus stop system; allowing the bus stop system to transfer the bus ID notification signal to the center system; allowing the center system requiring video information to output a route bus video transmission request signal for the route bus system to the bus stop system on the basis of a bus ID and a bus stop ID in response to the transferred bus ID notification signal; allowing the bus stop system to transfer the route bus video transmission request signal to the route bus system having the bus ID; allowing the route bus system having received the route bus video transmission request signal therein to output video information acquired by the imaging device to the bus stop system; and allowing the bus stop system having received the video information therein to transfer the video information to the center system.

An intersection video acquiring method according to yet another typical embodiment of the present invention is related to a traffic system comprising a route bus system installed in each of route buses and having a display part, and an intersection system having an imaging device for acquiring video. The intersection video acquiring method comprises the steps of: allowing the intersection system to periodically output an intersection ID notification signal; allowing the route bus system to receive the intersection ID notification signal therein and allowing the route bus system to output a bus ID notification signal to the intersection system; allowing the intersection system having received the bus ID notification signal therein to output a video delivery signal for causing the route bus system to start a process for receiving a video signal to the route bus system; allowing the route bus system having received the video delivery signal therein to start the video signal receiving process; transmitting the video signal to the route bus system after the video delivery signal output step; and allowing the route bus system having received the video signal therein to display the video signal over the display part.

An intersection video acquiring method according to a still further typical embodiment of the present invention is related to a traffic system comprising an intersection system having an imaging device for acquiring video, and a center system having a display part and coupled to the intersection system via a network. The intersection video acquiring method comprises the steps of: allowing the center system to output an intersection ID notification transmission interval designation signal for causing the intersection system to set a cycle at which an intersection ID notification signal is outputted; allowing the intersection system having received the intersection ID notification transmission interval designation signal therein to output the intersection ID notification signal for causing the center system to start a video receiving process; allowing the intersection system to output a video signal to the center system after the intersection ID notification signal output step; and outputting the video signal received by the center system to the display part.

A video delivery method according to a still further typical embodiment of the present invention is related to a traffic system comprising a route bus system installed in each of route buses, a bus stop system, and a center system coupled to the bus stop system via a network. The video delivery method comprises the steps of:

allowing the center system to output a video delivery signal added with a bus ID to the bus stop system in order to execute a process for relaying a video signal; allowing the bus stop system to start a relay process in response to the video delivery signal and allowing the bus stop system to transfer the video delivery signal to the route bus system having the bus ID in order to start a process for receiving the video signal; allowing the route bus system to start a video receiving process in response to the transfer of the video delivery signal; transmitting the video signal to the bus stop system after the video delivery signal transmitting step; and allowing the bus stop system to transfer the video signal to the route bus system.

Advantageous effects obtained by a typical one of the inventions disclosed in the present application will be described in brief as follows:

A bus location indicating method according to a typical embodiment of the present invention is used to make it possible to build a bus location system using a narrow-band communication system.

It is possible to deliver a video image photographed at a bus and a video image photographed at a bus stop or an intersection to a center or the like through the use of the so-built bus location system. In addition, advertising video images can be sent from the center to each route bus.

### BRIEF DESCRIPTION OF THE DRAWINGS

FIG. 1 is a conceptual diagram showing operation modes of a bus location system according to the present invention;

FIG. 2 is a block diagram illustrating a configuration of a bus stop system;

FIG. 3 is a block diagram showing a configuration of a route bus system;

FIG. 4 is a block diagram illustrating a configuration of a center-side system;

FIG. 5 is a flowchart showing a method for coupling the route bus system to the bus stop system;

FIG. 6 is a diagram showing one example of a data configuration of a bus stop ID notification signal contained in a beacon;

FIG. 7 is a data configuration diagram, wherein FIG. 7(a) is a diagram showing one example of a data configuration of a bus ID notification signal, and FIG. 7(b) is a diagram showing one example of a data configuration of another bus ID notification signal, respectively;

FIG. 8 is a flowchart showing a flow of processing at a roadside I/O unit of the bus stop system at the reception of a bus ID notification signal;

FIG. 9 is a diagram showing a data configuration of a bus system coupling notification signal;

FIG. 10 is a diagram illustrating a data configuration of a bus system coupling release notification signal;

FIG. 11 is a table showing a correspondence between a bus ID and a route ID available for use in a roadside I/O unit of each bus stop system;

FIG. 12 is a flowchart related to a process of a center at the reception of a bus system coupling notification signal;

FIG. 13 is a diagram showing one example of a data configuration of bus location update information;

FIG. 14 is a displayed example of a display screen of a roadside I/O unit;

FIG. 15 is a block diagram illustrating a configuration of a route bus system according to a second embodiment of the present invention;

FIG. 16 is a flowchart related to a video acquiring process of the center according to the second embodiment of the present invention;

FIG. 17 is a diagram showing one example of a data configuration of a route bus video transmission request signal;

FIG. 18 is a flowchart related to a video relay process of a bus stop system according to the second embodiment of the present invention;

FIG. 19 is a flowchart related to an imaging process operated by the route bus system according to the second embodiment of the present invention;

FIG. 20 is a block diagram of a bus stop system according to a third embodiment of the present invention;

FIG. 21 is a flowchart related to a video transmitting process of the bus stop system according to the third embodiment of the present invention;

FIG. 22 is a diagram showing one example of a data configuration of a video delivery signal;

FIG. 23 is a flowchart showing a video receiving process of a roadside wireless unit according to the third embodiment of the present invention;

FIG. 24 is a flowchart showing a video transmission request/video receiving process according to a fourth embodiment of the present invention;

FIG. 25 is a flowchart related to a video transmitting process of a bus stop system according to the fourth embodiment of the present invention;

FIG. 26 is a flowchart showing a video transmitting process by the center according to a fifth embodiment of the present invention;

FIG. 27 is a diagram showing one example of a data configuration of a video delivery signal transmitted by the center according to the fifth embodiment of the present invention;

FIG. 28 is a flowchart showing a relay process of a roadside I/O unit according to the fifth embodiment of the present invention; and

FIG. 29 is a flowchart related to a video signal receiving process of a route bus system according to the fifth embodiment of the present invention.

### DETAILED DESCRIPTION OF THE PREFERRED EMBODIMENTS

Preferred embodiments of the present invention will hereinafter be described using the accompanying drawings.

### First Embodiment

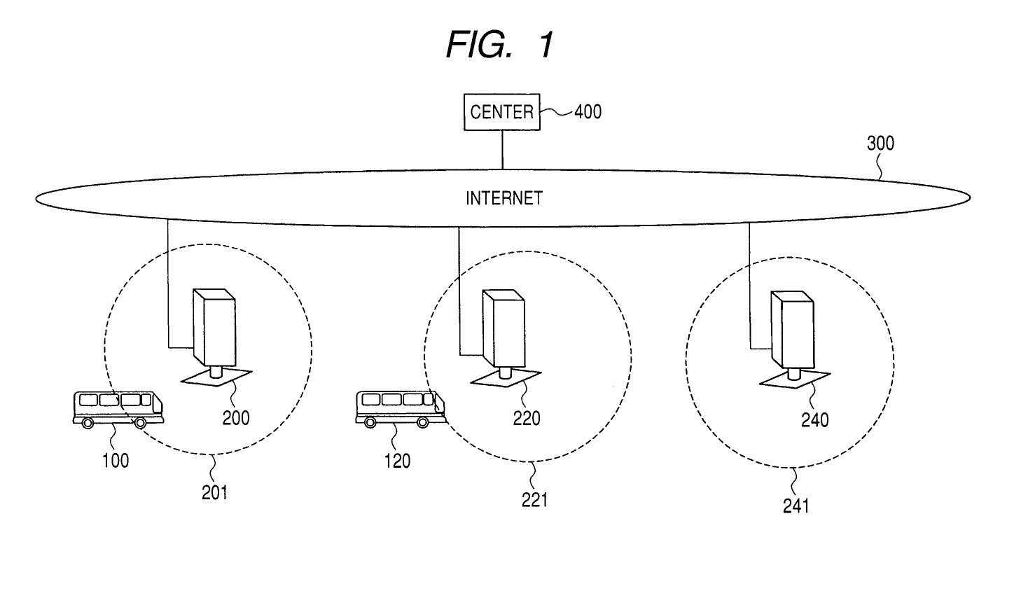

FIG. 1 is a conceptual diagram showing operation modes of a bus location system according to the present invention.

The same figure shows how the system relates on the service of route buses 100 and 120 which run on business among bus stops 200, 220 and 240.

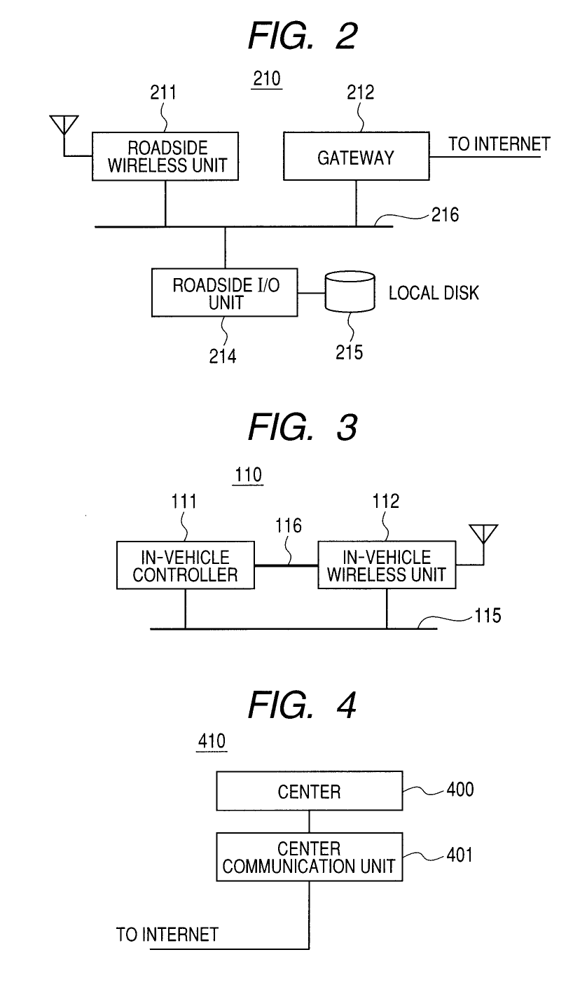

A bus stop system 210 shown in FIG. 2 is included in each bus stop. FIG. 2 is a block diagram showing a configuration of the bus stop system 210. The bus stop system 210 comprises a roadside wireless unit 211, a gateway 212, a roadside I/O unit 214, a local disk 215 and a communication path 216.

The roadside wireless unit 211 is of a wireless communication transceiver based on communication specifications of a wireless LAN, such as IEEE802. 11p. The wireless LAN is a standard definite in master (access point)/slave (client), but the roadside wireless unit 211 corresponds to the access point. Thus, the roadside wireless unit 211 has the function of outputting a beacon. While a bus stop ID notification signal is contained in the beacon, the roadside wireless unit 211 also has the function of generating data thereof.

Access point areas 201, 221 and 241 in which a route bus system 110 is capable of communicating with the roadside wireless unit 211 are determined according to the output performance of the roadside wireless unit 211.

The gateway 212 is of a controller which has two or more ports each having the function of communication between LAN in the bus stop system 210 and its corresponding Internet 300 and which performs IP routing of communications on the Internet 300 communicated at a global IP address and communications on the communication path 216, transferred at a private IP address.

While the bus stop system 210 contained in each bus stop is coupled to a center 400 via the Internet 300 or the like, the gateway 212 serves as a contact therefor.

The roadside I/O unit 214 is of an electronic device that includes a display unit or part which displays the position or location of each route bus. At the present time, a PC or the like is assumed to be used therefor, but a built-in environment (function-limited device operated by DSP or the like) or the like is also included within the range.

The local disk 215 is of a local disk for storing a program, system information and the like used in the roadside I/O unit 214 or the like.

The communication path 216 is a communication path which couples respective models lying within the bus stop system 210. Although a general wired LAN is assumed here, it is not particular about this.

The route bus system 110 included in the route bus 100 or the like will next be explained. FIG. 3 is a block diagram showing a configuration of the route bus system 110.

The route bus system 110 includes an in-vehicle controller 111, an in-vehicle wireless unit 112, a communication path 115 and a physical signal line 116.

The in-vehicle controller 111 is of a controller for controlling the entire route bus system 110. The in-vehicle controller 111 is assumed to mainly perform a process (relation to IEEE1609. 3) of communication outside the in-vehicle device system 100.

The in-vehicle wireless unit 112 is of a transceiver for performing communications based on IEEE802. 11q or the like with the roadside wireless unit 211 of the bus stop system 210. While IEEE802. 11q has a master/slave relationship, the in-vehicle wireless unit 112 corresponds to the slave (client). While the session with the roadside wireless unit 211 is not being made, the in-vehicle wireless unit 112 detects the intensity of a beacon from the roadside wireless unit 211. If a predetermined or more signal intensity is given, then the in-vehicle wireless unit 112 has the function of making coupling to the roadside wireless unit 211 that serves as its output source.

The in-vehicle controller 111 and the in-vehicle wireless unit 112 are coupled to each other by the physical signal line 116 to be described later. It is thus possible to perform a transfer of data between the in-vehicle controller 111 and the in-vehicle wireless unit 112, notification of the presence or absence of received data and a beacon therebetween, etc. regardless of the status of use of the communication path 115. The in-vehicle wireless unit 112 is also capable of performing processing of such an extent as to output a signal to the outside, in accordance with instructions issued from the in-vehicle controller 111. Namely, the in-vehicle wireless unit 112 is of a microcomputer which performs processing using a built-in CPU and can be taken as one having the following functions.

1) Wireless communication function as a slave for IEEE802. 11, 2) Function that performs communications with the in-vehicle controller 111 via the physical signal line 116, and 3) Function that performs communications with the in-vehicle controller 111 or the like via the communication path 115. Action for the in-vehicle wireless unit 112 will be explained using the function of above 2 as being transmitted to the in-vehicle controller 111.

The communication path 115 is of a communication path which couples individual modules of the route bus system 110. Although a general wired LAN is assumed to be used even in the route bus system 110, it is not particular about this. Incidentally, in the present embodiment, no processing is done using the communication path 115. Thus, in the present embodiment, IP addresses for ports coupled to the communication path 115 are not defined.

The physical signal line 116 is of a communication bus such as PCI or the like, which links between the in-vehicle controller 111 and the in-vehicle wireless unit 112. It is thus possible to communicate between the in-vehicle controller 111 and the in-vehicle wireless unit 112 regardless of the status of use of the communication path 115.

A center side system 410 includes a center 400 and a center communication unit 401. FIG. 4 is a block diagram showing a configuration of the center side system 410.

The center 400 is of a service provider module which offers various services to the bus stop system 210 of each bus stop.

The center communication unit 401 is of a transceiver for communicating with a roadside communication unit 213 of the bus stop system 210. The roadside communication unit 213 and the center communication unit 401 are coupled to each other through the Internet 300. It can be said that the communication between the two corresponds to the communication between network layers.

The allocation of IP addresses within the route bus system 110 and to the bus stop system 210 is performed by private addresses respectively independent of each other. 172. 18. a. b (where a and b differ every device) is defined within the route bus system 110, and 172. 16. c. d (where c and d differ every device) is defined within the bus stop system 210.

The following will hereinafter be assumed to be used for the allocation of IP addresses in the present embodiment.

A port for a wired section of the roadside wireless unit 211 within the bus stop system 210: 172. 16. 10. 1, a port for a wired section of the gateway 212 within the bus stop system 210: 172. 16. 110. 1, and a port for a wired section of the roadside I/O unit 214 within the bus stop system 210: 172. 16. 210. 1. Incidentally, the above are illustrated as examples. It means that a network address is used in common but host addresses are different from each other. The following allocation of IP addresses is also similar to the above.

The in-vehicle wireless unit 112 of each route bus system 110 and the roadside wireless unit 211 of each bus stop system 210 are coupled to each other by a wireless LAN (e.g., IEEE802. 11P) and thereby routing is performed by IP.

The following IP addresses are allocated to a wireless circuit section between the in-vehicle wireless unit 112 and the roadside wireless unit 211 during wireless sections immediately after they have been linked to each other.

A port for a wireless section of the in-vehicle wireless unit 112: 172. 10. 30. 1, and a port for a wireless section of the roadside wireless unit 211: 172. 10. 10. 1. Incidentally, although they are described assertively here, there is a possibility that a plurality of route buses (and route bus systems 110) will be contained within a communication range of the roadside wireless unit 213 of one bus stop system 210. At this time, another address (hot address different from above, such as 172. 10. 11. 1) is allocated to the roadside wireless unit 211.

Thus, the allocation of the IP addresses is performed for each of the communication path 115 lying in each route bus, the wireless section between the in-vehicle wireless unit 112 and the roadside wireless unit 211 and the communication path 216 lying in each bus stop system 210, thereby making it possible to reduce the number of nodes for routing and a load on a network.

The in-vehicle wireless unit 112 and the roadside wireless unit 211 are respectively unified as a gateway for the route bus system 110 and a gateway for the bus stop system 210 within the route bus system 110, the wireless section between the in-vehicle wireless unit 112 and the roadside wireless unit 211 and the bus stop system 210, thereby making it possible to bind up IP addresses for the wired and wireless sections of the in-vehicle wireless unit, whereby routing becomes easy.

Although the in-vehicle LAN has been described as wired herein, the communication path 115 may be replaced with a wireless LAN. Although the IP address has been assumed as IPv4 for convenience of explanation, it may be taken as IPv6.

Refer back to the description of FIG. 1.

Each of the route buses 100 and 120 detects reception sensitivity of a beacon from the roadside wireless unit 211 of each bus stop system 210 while driving and detects whether it belongs to a wireless area covered with the roadside wireless unit 211 of each bus stop. When it belongs to the wireless area, each of the route buses communicates with its corresponding bus stop system 210 to make coupling to the bus stop system, thereby detecting the current location of the corresponding bus.

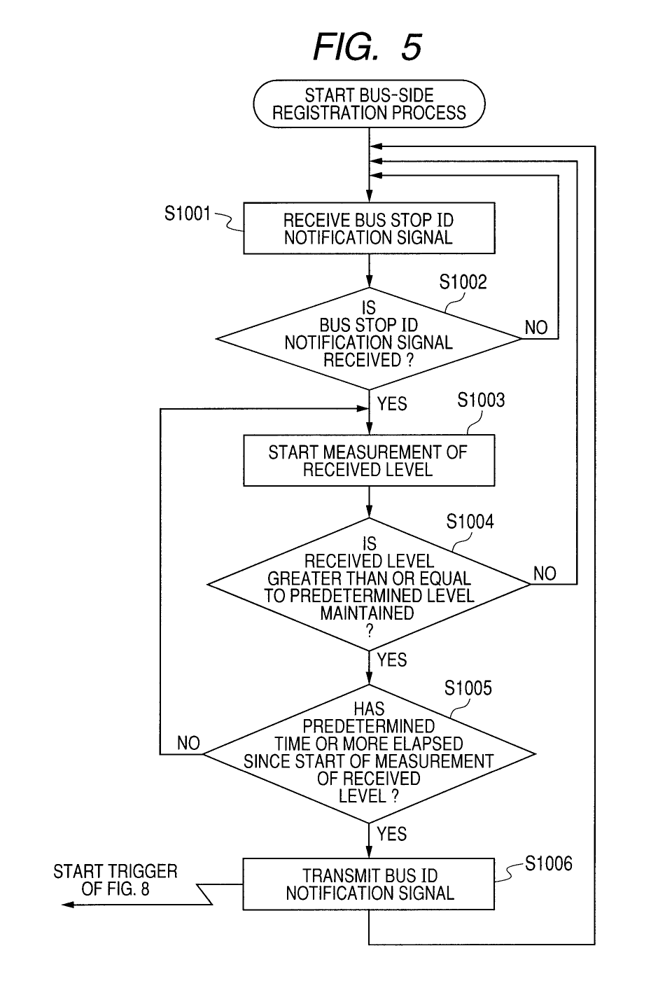

FIG. 5 is a flowchart showing a method of coupling the route bus system 110 to the bus stop system 210.

The in-vehicle wireless unit 112 starts the reception of a bus stop ID notification signal contained in a beacon and outputted from the roadside wireless unit 211 (Step S1001).

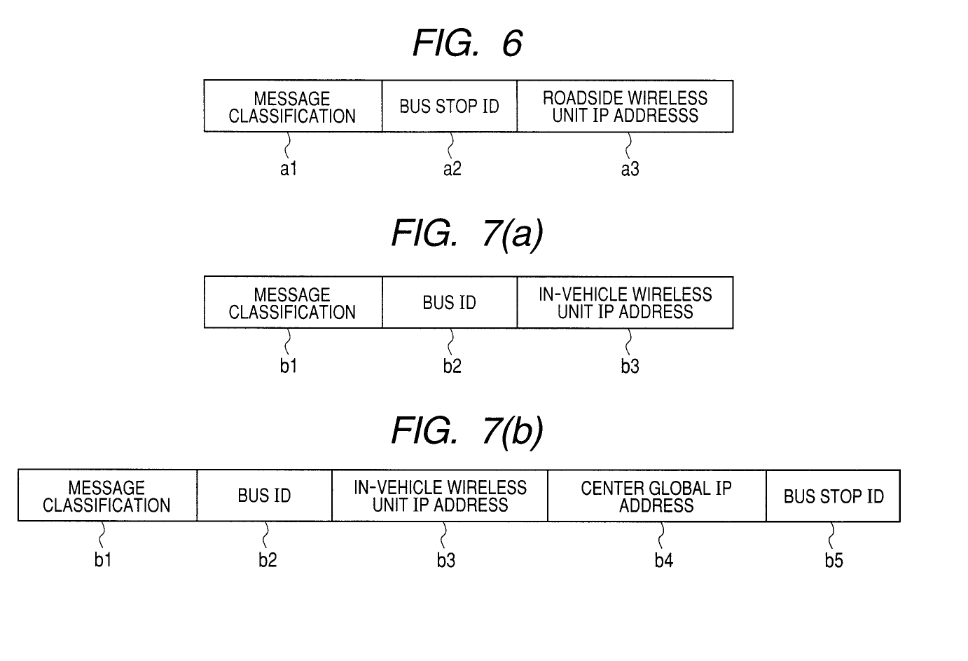

FIG. 6 is a diagram showing one example of a data configuration of the bus stop ID notification signal contained in the beacon.

As mentioned herein, the bus stop ID notification signal is of data outputted from the roadside wireless unit 211 of the roadside system 210 to the in-vehicle wireless unit 112. The bus stop ID notification signal includes a message classification field a1, a bus stop ID field a2, and a roadside wireless unit ID address field 3a.

The message classification field a1 is of a data field indicative of what this signal means.

The bus stop ID field a2 is of a data field descriptive of ID of the source bus stop system 210. The in-vehicle controller 111 is capable of recognizing with which bus stop the in-vehicle controller 111 communicates by taking a look at the bus stop ID.

The roadside wireless unit IP address field a3 is of a data field for storing therein an IP address for the roadside I/O unit 214 of each bus stop system. In the present embodiment, “172. 16. 210. 1” is written in the roadside wireless unit IP address field a3.

Incidentally, the IP address of the roadside wireless unit 211 is grasped by the in-vehicle wireless unit 112 in the process of a link in the wireless circuit section.

When the in-vehicle wireless unit 112 of the route bus system 110 receives the bus stop ID notification signal therein (Step S1002: Yes), the in-vehicle wireless unit 112 starts the measurement of a received level and starts the establishment of a link with the roadside wireless unit 211 (Step S1003).

When the received level cannot be maintained at a predetermined value (Step S1004: No), that is, when the distance from each of the access point areas 201, 221 and 241 is increased to cause a non-communicable state or when it becomes difficult to establish the link due to an increase in noise or the like, the processing is retuned to the reception of the bus stop ID notification signal (Step S1001).

When the received level is maintained at the predetermined value (Step S1004: Yes) and a predetermined period has elapsed (Step S1005: Yes), the link has already been established between the roadside wireless unit 211 and the in-vehicle wireless unit 112. Since the event having occurred in the in-vehicle wireless unit 112 is grasped by the in-vehicle controller 111 in the present embodiment, the in-vehicle controller 111 instructs the in-vehicle wireless unit 112 to transmit a bus ID notification signal to the roadside wireless unit 211 (Step S1006). At this time, the transmission of the bus ID notification signal from the roadside wireless unit 211 is performed by unicast.

Incidentally, the above “predetermined period” is rendered long or short depending on the protocol used in the wireless section. If, for example, IEEE802. 11p (DSRC) for a motor vehicle is taken, then the predetermined period can also be set to a short period of time. If another IEEE802. 11 is taken, then the predetermined period should be set slightly long in consideration of even the establishment of the link. How this time should be set is of a design matter.

FIG. 7 is a data configuration diagram, wherein FIG. 7(a) is a diagram showing one example of a data configuration of a bus ID notification signal, and FIG. 7(b) is a diagram showing one example of a data configuration of another bus ID notification signal, respectively. Although the two types of bus ID notification signals shown in FIGS. 7(a) and 7(b) exist in the present drawing, the bus ID notification signal shown in FIG. 7(a) is used in the first embodiment.

The bus ID notification signal includes a message classification field b1, a bus ID field b2, and an in-vehicle wireless unit IP address field b3.

As mentioned above, the bus ID notification signal is of a signal which is sent to the roadside I/O unit 214 of the bus stop system 210 in which the link is extended, at Step S1006.

The message classification field b1 is of a data field indicative of what this signal means.

The bus ID field b2 is of a data field descriptive of ID for the source route bus system 110. The bus ID corresponds to ID allocated one to one route bus system 210. It is thus possible to grasp with which route bus the bus stop system 210 is communicating.

Owing to the existence of the bus ID field b2, the bus ID notification signal can be determined to be an invalid signal when it reaches an adjacent bus stop due to overreach or the like, thereby making it possible to prevent the bus ID notification signal from being relayed to the center 400 unnecessarily.

The in-vehicle wireless unit IP address field b3 is of a data field descriptive of an IP address for the in-vehicle wireless unit 112. In the present embodiment, “172. 10. 30. 1” is written in this field.

By performing the above processing, the route bus system 110 is coupled to the bus stop system 210. Even after their coupling, the processing is returned to Step S1001 in order to receive each bus stop ID notification signal transmitted periodically (described later).

A description will next be made of what processing is done by the bus stop system 210 in response to the bus ID notification signal transmitted from the in-vehicle wireless unit 112 at Step S1006.

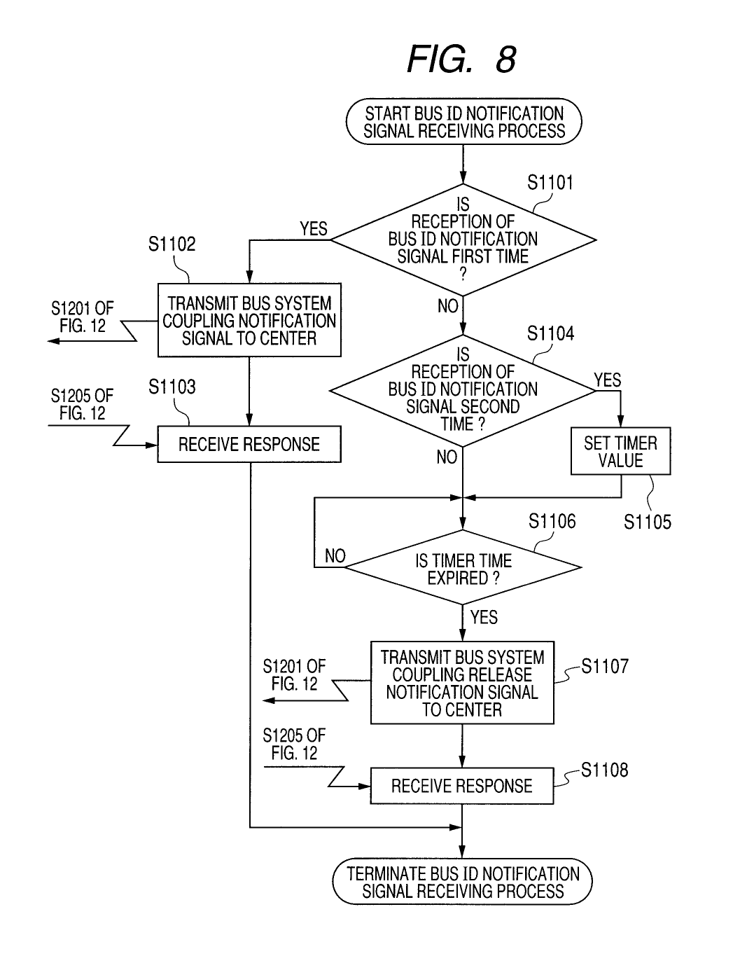

FIG. 8 is a flowchart showing the flow of processing at the roadside I/O unit 214 of the bus stop system 210 at the reception of a bus ID notification signal.

When the bus ID notification signal is received, it is first determined whether the bus ID notification signal was received in the past (Step S1101). At this time, the “past” is assumed to be after the start of commercial operation of a route bus currently in operation, but it is not particular about this.

When the bus ID notification signal was not received in the past (Step S1101: Yes), the reception of the bus ID notification signal is notified to the center 400 by unicast (Step S1102). At this time, it is performed by notifying a bus system coupling notification signal to the center 400.

If necessary, then a port number (“172. 10. 30. 1” in the present embodiment) for a wireless section of the in-vehicle wireless unit 112 and its corresponding bus ID are recorded in association with each other at Step S1102. It is thus possible to perform a process for relaying communications from the center side such as shown in a second embodiment to be described later.

A response of a bus location update signal to the above signal is received from the center 400 side (Step S1103).

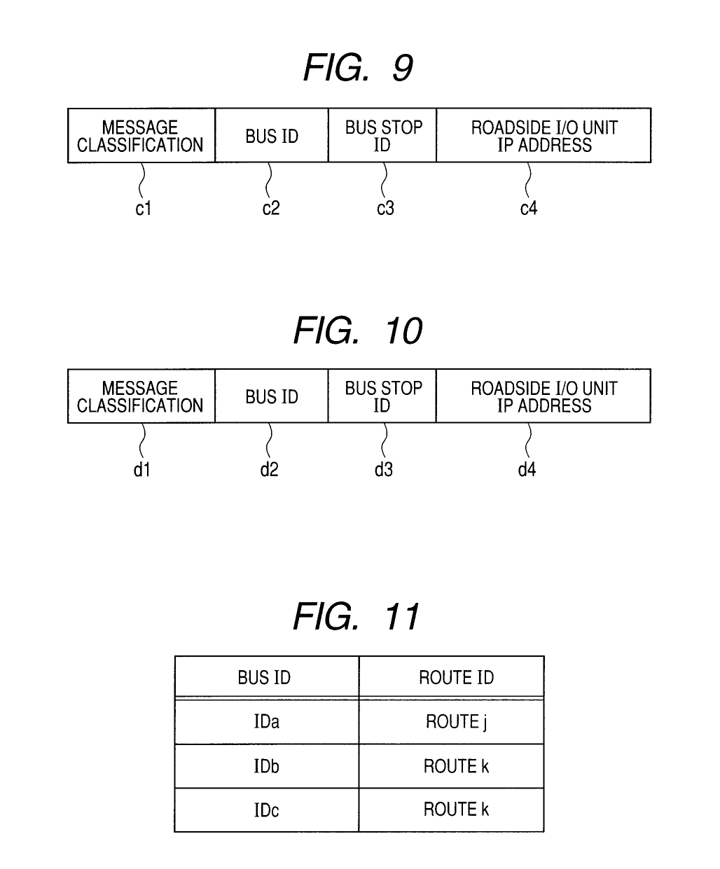

FIG. 9 is a diagram showing a data configuration of the bus system coupling notification signal. The bus system coupling notification signal includes a message classification field c1, a bus ID data field c2, a bus stop ID field c3, and an IP address (bus stop system global IP address) c4 of a roadside I/O unit.

The message classification field c1 is of a data field indicative of what this signal means.

The bus ID data field c2 is of a data field based on the bus ID field b2 of the bus ID notification signal. The bus stop ID field c3 is of an identifier for the bus stop system 210 corresponding to a transmission source. Transmitting these to the center 400 enables the management of information on the location of each route bus.

The IP address (bus stop system global IP address) c4 of the roadside I/O unit is of a data field indicative of a global IP address allocated to each bus stop system 210.

On the other hand, when the bus ID notification signal was received in the past (Step S1101: No), it is confirmed whether this corresponds to a second reception (Step S1104). If it is found to be the second reception (Step S1104: Yes), then a timer is set, and the route bus is assumed to be separated or moved away from a communicable range of the bus stop system 210, and the time required to report it to the center 400 is set (Step S1105).

On the other hand, if it is found not to be the second reception (Step S1104: No), it is then considered that a timer operation is performed on the corresponding route bus system on the bus stop system. Accordingly, the process of the timer operation already in progress is continued.

If the timer time is expired (Step S1106: Yes), then a bus system coupling release notification signal is transmitted to the center 400 by unicast again (Step S1107). A response of a bus location update signal to this signal is awaited from the center side (Step S1108).

At this time, the recording of both the bus ID and the port number for the wireless section of the in-vehicle wireless unit 112, which has been carried out at Step S1102, may be cleared.

FIG. 10 is a diagram showing a data configuration of the bus system coupling release notification signal. The bus system coupling release notification signal includes a message classification field d1, a bus ID data field d2, a bus stop interval ID data field d3, and an IP address (bus stop system global IP address) field d4 of a roadside I/O unit. Of these, the message classification field d1, bus ID data field d2 and bus stop system global IP address d4 are the same as those shown in FIG. 8. Only the bus stop interval ID data field d3 will therefore be described.

The bus stop interval ID data field d3 is of a data field indicating that the corresponding route bus has been moved away from the bus stop system 210. A value stored in this data field can be drawn by an unillustrated route ID indicative of the route for the corresponding route bus and a bus stop ID for the bus stop system 210 corresponding to the source of output of the bus system coupling release notification signal.

FIG. 11 is a table showing a correspondence between a bus ID and a route ID available for use in the roadside I/O unit 214 of each bus stop system 210. The corresponding table is delivered from the center 400 to each bus stop system 210 before business. The bus stop interval ID data field d3 is defined referring to the table.

The behaviors of the center 400 side will next be explained.

As main operations of the center 400, may be mentioned: 1) setting of an interval for notification of a beacon (and bus stop ID notification signal contained in the beacon) to each bus stop system 210, 2) supporting for a bus system coupling notification signal transmitted from each bus stop system 210, 3) supporting for a bus system coupling release notification signal transmitted from each bus stop system 210, and 4) delivery of the table shown in FIG. 11 to each bus stop system 210. Of these, 4) will not be explained because it may be performed based on the general network communication.

1) relates to S1001-S1102 of FIG. 5. Namely, the individual route buses enter the access point areas 201, 211 and 241 of the bus stop systems 210 asynchronously. Thus, if the bus stop ID notification signal is not notified in a predetermined cycle, then a notification leak occurs.

On other hand, there is also considered a meaningless case even though the bus stop ID notification signal is outputted so frequently depending on the operation situation or status.

It is therefore possible to set an output interval of a bus stop ID notification signal to the roadside I/O unit 214 of each bus stop system 210 from the center 400. The roadside I/O unit 214 may set the bus stop ID notification signal, based on the set value thereof so as to transmit the bus stop ID notification signal.

Here, the set value of the beacon output interval T is represented as follows:

T=To/v

where To: beacon initially set value, and v: mean vehicle speed of route bus. The center 400 notifies the set value to the roadside I/O unit 214 of each bus stop system 210. The roadside I/O unit 214 sets the set value to the roadside wireless unit 211 lying within own bus stop system 210 to complete the setting of the beacon output interval.

Incidentally, the beacon output interval is not particular about the above, but should be suitably set according to the system's operation status. There may be mentioned, for example, a more reduction in the output interval in the case of a time zone at which a jam or the like occurs, etc.

The above 2) and 3) will next be explained.

After a beacon outputted from a given roadside wireless unit 211 has been received, the bus system coupling notification signal is outputted with the reception of the first bus ID notification signal outputted from its corresponding in-vehicle wireless unit 112 as a trigger (Step S1102 of FIG. 8). This bus system coupling notification signal is outputted from the roadside I/O unit 214.

The bus system coupling release notification signal is of a signal which belongs to an access point area of a certain bus stop system and is outputted from the roadside I/O unit with the corresponding route bus being quasi-controlled with respect to one separated or moved away from the corresponding access point area after a “predetermined period” has elapsed.

The center 400 updates management data of each route bus, which is contained in itself when it receives these signals, and outputs bus location update information not only to the source of transmission but also to the bus stops (all or part thereof) through which the route bus passes.

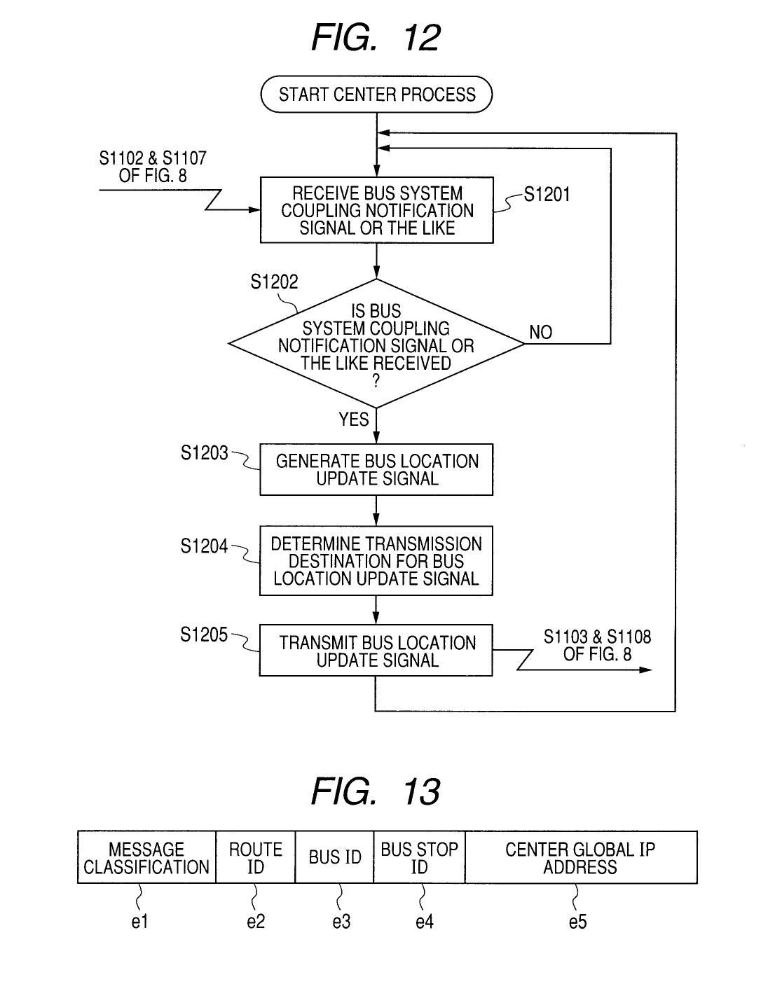

A description will be made of what the center 400 performs upon the output of the bus location update information using FIG. 12. FIG. 12 is a flowchart related to a process at the reception of a bus system coupling notification signal by the center 400. Incidentally, the term “bus system coupling notification signal or the like” described in the present figure means both of the bus system coupling notification signal and the bus system coupling release notification signal.

When the process of reception of the bus system coupling notification signal by the center 400 is started up, the center 400 starts the reception of the bus system coupling notification signal and the bus system coupling release notification signal (Step S1201). If the reception thereof is found not to exist, then the process of reception of the bus system coupling notification signal or the like by the center 400 is placed in standby as it is (Step S1202: No). On the other hand, if the reception of the bus system coupling notification signal or the like is done (Step S1202: Yes), then the center 400 generates a bus location update signal (Step S1203). Thereafter, the center 400 determines whether or not to transmit the generated bus location update signal to any bus stop (Step S1204). The center 400 outputs the corresponding bus location update signal to the determined transmission destination (Step S1205). Its output destination is determined by drawing a route ID corresponding to a bus IDc2 for a bus system coupling notification signal from the table shown in FIG. 11. As a method for transmitting bus location update signals, they may respectively be transmitted to all transmission destinations determined by unicast or may be transmitted collectively by multicast.

Whether or not to output the bus location update signals to all bus stop systems related to route IDs, output them only to bus stops adjacent to a bus stop corresponding to a transmission source (inclusive of how to define “neighborhood”), or transmit them even to bus stops through which the bus has passed, is of a design matter.

The bus location update signal will be explained. FIG. 13 is a diagram showing one example of a data configuration of the bus location update signal. The bus location update signal includes a message classification field e1, a route ID field e2, a bus ID field e3, a bus stop ID field e4, and a center global IP address field e5.

The message classification field e1 is of a data field indicative of what this signal means. Incidentally, the center 400 may alter or change the value of the message classification field e1 according to the response to Step S1102 of FIG. 8 and the response to Step S1107 of FIG. 8 or may keep it identical.

The route ID field e2 is of a data field which describes a route ID drawn out from the table of FIG. 11 by the center 400. After the generation of the bus location update signal, the center 400 determines a destination to transmit the corresponding bus location update signal at Step S1204 using the route ID described in the data field.

The bus ID field e3 is of a data field descriptive of ID for a route bus system 110 target for updating. The value of the bus ID field c2 of FIG. 9 and the value of the bus ID field d2 of FIG. 10 are used as they are.

The bus stop ID field e4 is of a data field indicative of ID for a bus stop system corresponding to the source of output of a bus system coupling notification signal or the like. Upon the response to the bus system coupling notification signal, the value of bus stop ID field c3 of FIG. 9 can be used as it is. Upon the response to the bus system coupling release notification signal, the value of the bus stop interval ID data field d3 of FIG. 10 can be used as it is.

The center global IP address is of a data field indicative of a global IP address allocated to the center communication unit 401 on the center side.

The center 400 outputs the bus location update signal to each bus stop system related to its corresponding route ID field. The transmission source receives it at Steps S1103 and S1108 of FIG. 8.

The roadside I/O unit 214 of each bus stop system 210 other than the transmission source updates a display screen in response to the bus location update signal if necessary.

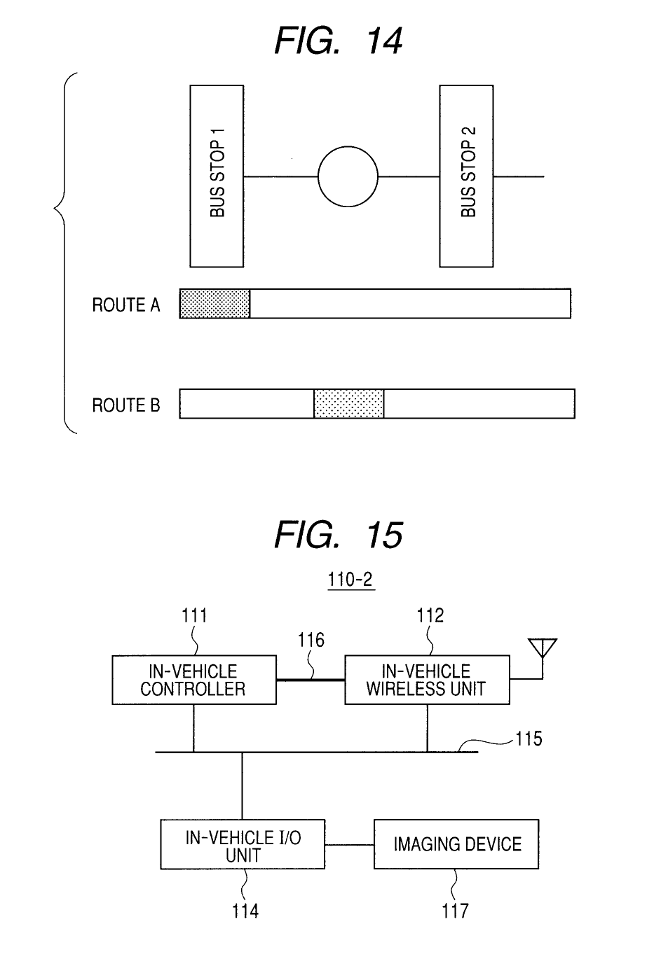

FIG. 14 shows a display example of the display screen of the roadside I/O unit 214.

In the display example, a “bus stop 2” indicates a bus stop provided with a bus stop system 210 in which a roadside I/O unit 214 being under execution of its display at present exists. A “bus stop 1” indicates a bus stop lying immediately before the “bus stop 2”.

Here, operation statuses of two route buses are displayed depending on the routes. Of these, the route A is a display taken when the bus location update signal corresponding to the response to the bus system coupling notification signal (Step S1102) is received. The route B is a display taken when the bus location update signal corresponding to the response to the bus system coupling release notification signal (Step S1107) is received.

Thus, when a route bus enters an access point area of each bus stop system and a predetermined period has elapsed after it has entered the access point area thereof, a screen display is switched over to another, thereby making it possible to build a bus location system easily.

Incidentally, the roadside I/O unit 214 of the bus stop system 210 corresponding to the output source of the bus system coupling notification signal or the like may not switch the display in particular even when it receives the responses of the bus location update signals at Steps S1103 and S1108. This is because the display can be changed over by internal processing when the bus system coupling notification signal or the like is transmitted.

Using the bus location system built as described above makes it possible to reliably display a bus location using a narrowband wireless system like a wireless LAN even without providing a location detecting means such as a GPS.

### Second Embodiment

A second embodiment of the present invention will next be explained. The present embodiment aims to relay an in-vehicle video to the center via each bus stop system.

Differences between a hardware configuration of the present embodiment and the hardware configuration of the first embodiment reside in a route bus system. FIG. 15 is a block diagram showing a configuration of a route bus system 110-2 according to the second embodiment of the present invention.

The route bus system 110-2 includes an in-vehicle controller 111, an in-vehicle wireless unit 112, a communication path 115, and a physical signal line 116 in a manner similar to the first embodiment. Even at other than the above, the route bus system features the provision of an in-vehicle I/O unit 114 and an imaging device 117. The second embodiment will be described below centering on the differences from the first embodiment.

The in-vehicle I/O unit 114 is of an electronic device which performs the delivery of a video image of the imaging device 117 to the bus stop system 210 side, processing from a video request issued from the bus stop system 210 side, etc. A PC or the like is assumed to be used for the in-vehicle I/O unit at the present time, but a built-in environment (function-limited device operated by DSP or the like) or the like is also included within the range.

The in-vehicle I/O unit 114 is coupled to the in-vehicle controller 111 and the in-vehicle wireless unit 112 through the communication path 115. Such a configuration enables a reduction in the load on the in-vehicle controller 111 even upon transmission of a large volume of video data. In conjunction with it, an advantage can also be obtained in that the setting to the in-vehicle I/O unit 114 can be performed directly from the in-vehicle controller 111 via the communication path 115 if necessary.

The in-vehicle I/O unit 114 is assumed to have a display part. The present embodiment, however, needs not to use the display part. There is considered an application such as the output of a route bus video from the imaging device 117 upon transmission. Incidentally, this display part is positively used in a third embodiment.

The imaging device 117 is of an electronic device capable of imaging motion pictures according to the request issued from the in-vehicle I/O unit 114. Although a CMOS or CCD solid-state image sensing device is assumed to be used as an imaging device, it is not particular about this.

An object for imaging of the imaging device 117 may be either the interior of a route bus or the exterior thereof. The imaging device may be set movable depending on a method for installing the imaging device, but is a design matter. It will therefore not be described in detail in the present specification.

Unlike the first embodiment, the route bus system 110-2 is LAN-coupled via the communication path 115. In the present embodiment, IP addresses are allocated to the respective devices coupled to the communication path 115 in the following manner.

A port on the communication path side, of in-vehicle I/O unit: 172. 18. 10. 1, a port on the communication path side, of in-vehicle controller: 172. 18. 130. 1, and a port on the communication path side, of the in-vehicle wireless unit: 172. 18. 30. 1. An in-vehicle video imaging process using the route bus system 110-2 will next be explained.

A link is placed between the in-vehicle wireless unit 112 of the route bus system 110-2 and its corresponding roadside wireless unit 211 of the bus stop system 210. This process is similar to FIG. 5 related to the first embodiment. At the stage of transmission of the bus ID notification signal at Step S1006, a private address is similarly established between the in-vehicle wireless unit 112 and the roadside wireless unit 211.

A port for a wired section of the roadside wireless unit 211 in the bus stop system 210: 172. 16. 10. 1, a port for a wired section of the gateway 212: 172. 16. 110. 1, a port for a wired section of the roadside I/O unit 214: 172. 16. 210. 1, a port for a wireless section of the in-vehicle wireless unit 112 between the in-vehicle wireless unit 112 and the roadside wireless unit 211: 172. 10. 30. 1, and a port for a wireless section of the roadside wireless unit 211 therebetween: 172. 10. 10. 1. When the bus ID notification signal is transmitted at Step S1006 in a manner similar to the first embodiment, the roadside I/O unit 214 of the bus stop system 210 transmits a bus system coupling notification signal to the center 400. Processes subsequent to the above become operations peculiar to the second embodiment.

At this time, the bus ID notification signal is different from that employed in the first embodiment and becomes one added with additional information. FIG. 7(b) shows the bus ID notification signal employed in the second embodiment.

The bus ID notification signal includes a center global IP address b4 and a bus stop ID b5 in addition to a message classification field b1, a bus ID field b2 and an in-vehicle wireless unit IP address field b3. Since the b1 through b3 are similar to those employed in the first embodiment, only the center global IP address b4 and the bus stop ID b5 will be explained.

The center global IP address b4 is of a data field for storing a global IP address therein, which has been allocated to the center communication unit 401 of the center 400 corresponding to the transmission destination.

The bus stop ID b5 is of a data field for storing a bus stop ID for a communication destination at which the bus stop ID field a2 contained in the bus stop ID notification signal is copied. Here, “172. 16. 210. 1” is added thereto.

It is understood that the present embodiment is a rote bus system capable of transmitting video according to the difference in configuration between the data fields.

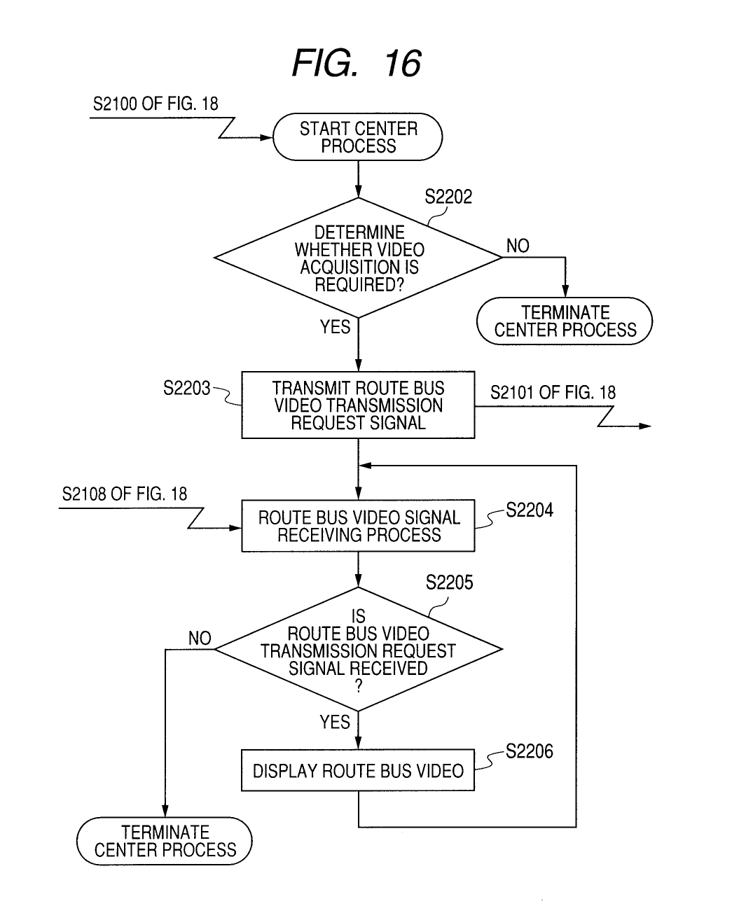

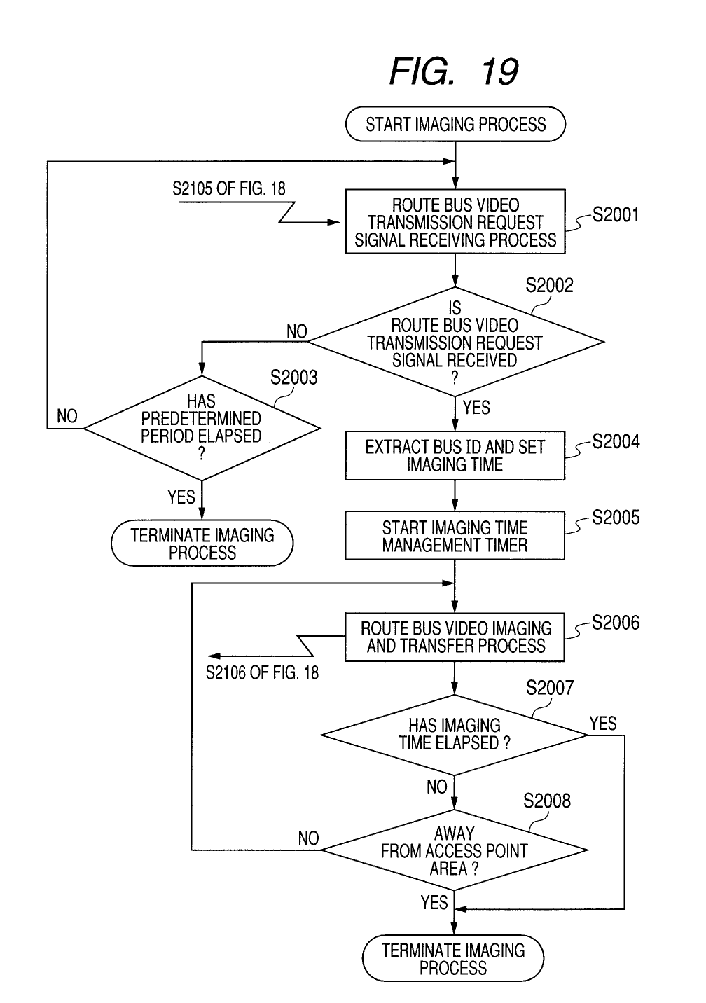

In response to it, the route bus system transfers the bus ID notification signal of FIG. 7(b) to the center 400 (Step S2100 of FIG. 18 to be described later). Thus, a video acquiring process of FIG. 16 is started up on the center 400.

FIG. 16 is a flowchart about a video acquiring process of the center 400 according to the second embodiment of the present invention. The operation of the center 400 will be explained based on the flowchart.

The center 400 first determines whether video acquisition is required (Step S2202). When the video is not required (Step S2202: No), the present process is terminated as it is.

When the video is required (Step S2202: Yes), the center 400 transmits a rout bus video transmission request signal to the roadside I/O unit 214 contained in the bus stop system 210, which provides a bus system coupling notification signal (Step S2203).

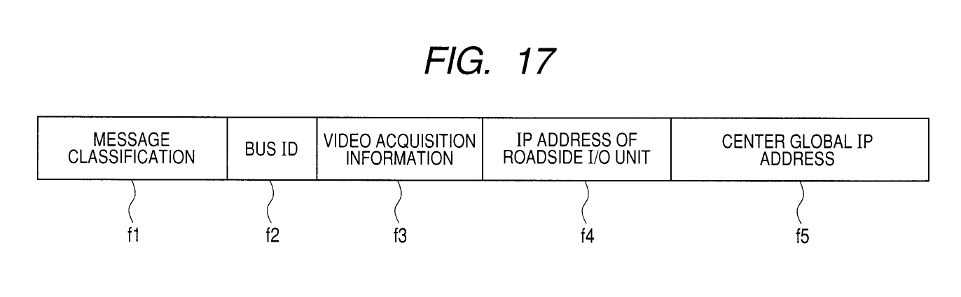

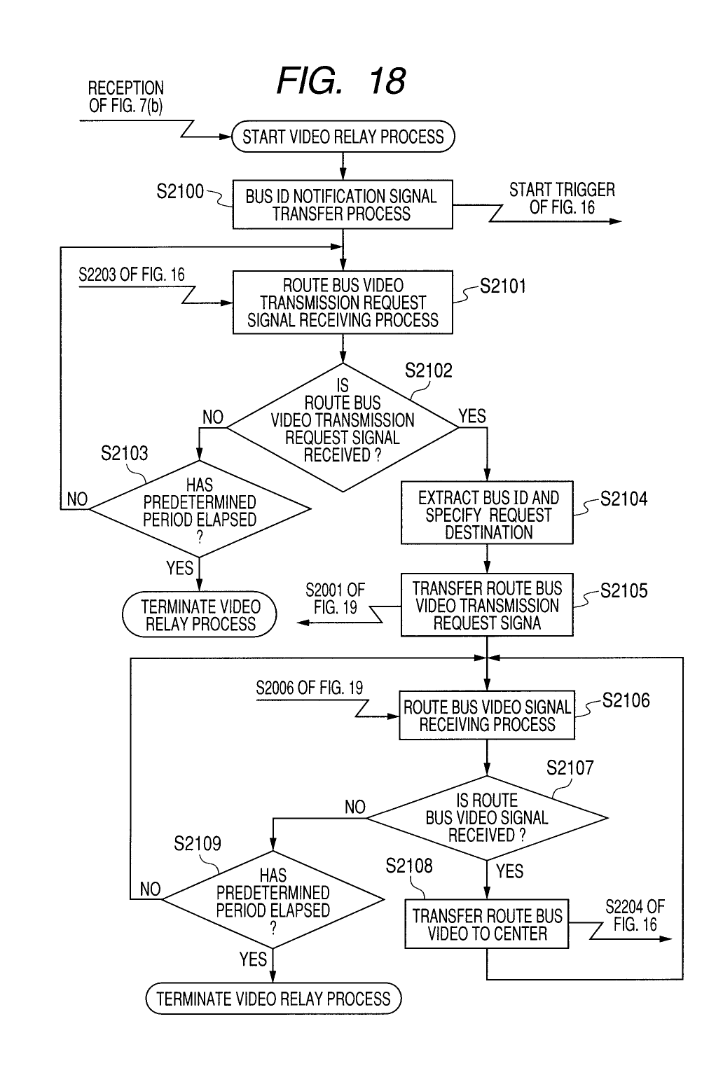

FIG. 17 is a diagram showing one example of a data configuration of the route bus video transmission request signal. The route bus video transmission request signal includes a message classification field f1, a bus ID data field f2, video capture or acquisition information f3, an IP address f4 for a roadside I/O unit, and a center global IP address f5.

The message classification field f1 is of a data field indicative of what this signal means.

The bus ID data field f2 is of a data field for storing a bus ID allocated to the route bus system 110-2 which is targeted for the need for video. The value of the bus ID data field of the received bus ID notification signal (FIG. 7(b)) is inputted as it is.

The video acquisition information f3 is of a data field for storing a video imaging time (transmission time) and the like therein.

The IP address f4 for the roadside I/O unit is of a data field for storing a private IP address for the roadside I/O unit 214. Here, “172. 16. 210. 1” is stored thereat.

The center global IP address f5 is of a data field indicative of a global IP address allocated to the center communication unit 401 on the center side.

The route bus video transmission request signal is transmitted to the roadside I/O unit 214 of the bus stop system 210 corresponding to a transmission source. Incidentally, although there is considered an IP masquerade or the like as an access means for a terminal to which a private address is allocated, its means is no object.

When the route bus video transmission request signal is transmitted, the center 400 receives a video signal for each route bus therein (Step S2204). If it is possible to receive the route bus video signal (Step S2205: Yes), then the center 400 displays its route bus video (Step S2206). If it is not possible to receive the route bus video signal (Step S2205: No), then the present process is terminated.

The present invention is thus characterized in that the center 400 is capable of acquiring an image of each route bus system by communicating with the roadside I/O unit 214 of each bus stop system 210.

The operation of the bus stop system 210 will next be explained. FIG. 18 is a flowchart about a video relay process of the bus stop system 210 according to the second embodiment of the present invention.

The roadside I/O unit 214 starts the video relay process with the reception of the bus ID notification signal of FIG. 7(b) as a trigger.

The roadside I/O unit 214 first transfers the received bus ID notification signal to the center 400 (Step S2100). This thus yields a trigger for starting the video acquiring process (refer to FIG. 16) on the center side.

If the video on the route bus system 110 side is necessary for the center 400, then the route bus video transmission request signal is transmitted from the center 400 at Step S2203 of FIG. 16. The roadside I/O unit 214 firstly performs the process of receiving the route bus video transmission request signal (Step S2101). If the roadside I/O unit 214 is not able to receive the route bus video transmission request signal (Step S2102: No), then a timeout process is performed (Step S2103) and the video relay process is terminated when a predetermined time has elapsed.

If the roadside I/O unit 214 is capable of receiving the route bus video transmission request signal (Step S2102: Yes), then the roadside I/O unit 214 extracts a bus IDf2 from the received route bus video transmission request signal to specify a route bus system corresponding to a transfer destination thereof (Step S2104). If the correspondence table or the like created at Step S1102 of FIG. 8, comprising each bus ID and the address of the port for the wireless section of each in-vehicle wireless unit 112 is used at this time, then the reduction of processing steps can be achieved. This is however not limited to it.

If it is possible to lead out the route bus system corresponding to the transfer destination, then the route bus video transmission request signal transmitted to its in-vehicle wireless unit 112 is transferred (Step S2105).

After the transfer thereof, the roadside I/O unit 214 performs the process of receiving the corresponding route bus video signal from the route bus system 110-2 side (Step S2106). If the route bus video signal can be received (Step S2107: Yes), then the received route bus video signal is transferred to the center 400 as data (Step S2108). This transmitted data is received by the center 400 at Step S2204 of FIG. 16.

If the roadside I/O unit 214 is not able to receive the route bus video signal (Step S2109), then the video relay process is terminated when a predetermined time has elapsed.

The operation of the route bus system 110-2 side will finally be explained using FIG. 19. FIG. 19 is a flowchart related to an imaging process operated at the route bus system 110-2 according to the second embodiment of the present invention.

When the route bus system belongs to its corresponding access point area of the bus stop system 210, the imaging process on the route bus system 110-2 side is started assuming the transmission (Step S1006 of FIG. 5) of the bus ID notification signal outputted from the in-vehicle wireless unit 112 of the route bus system 110-2 or the like as a start trigger.

The in-vehicle wireless unit 112 of the route bus system 110-2 first performs a process for receiving a route bus video transmission request signal (Step S2001). The route bus video transmission request signal is transferred from the bus stop system 210 at Step S2105 of FIG. 18. If it is not possible to receive the route bus video transmission request signal (Step S2002: No), then a timeout process is performed (Step S2003) and the imaging process is terminated when a predetermined time has elapsed.

If the in-vehicle wireless unit 112 is capable of receiving the route bus video transmission request signal (Step S2002: Yes), then the in-vehicle wireless unit 112 transmits the route bus video transmission request signal to the in-vehicle I/O unit 114 via the communication path 115. The in-vehicle I/O unit 114 acquires an imaging time from the video acquisition information f3. The acquired imaging time is set to an imaging time management or control timer managed by the in-vehicle I/O unit 114 (Step S2004). If the setting of the imaging time management timer is terminated, then the in-vehicle I/O unit 114 starts the timer (Step S2005).

After the startup of the timer has been ended, the in-vehicle I/O unit 114 starts the photographing or imaging of route bus video using the imaging device 117. The photographed route bus video is transmitted to the in-vehicle wireless unit 112 via the communication path 115 from which the route bus video is transmitted to the roadside I/O unit 214 of the bus stop system 210 to which the route bus system 110-2 belongs (Step S2006). The route bus video is received at Step 2106 of FIG. 18.

The in-vehicle I/O unit 114 monitors the imaging time management timer started at Step S2005. If the time of the timer is expired (Step S2007: Yes), then the imaging process is brought to a halt. Even when the route bus system 110-2 is moved away from the access point area of the bus stop system 210 corresponding to a communications partner due to the movement or the like of the route bus system 110-2 (Step S2008: Yes), the imaging process is halted.

By doing so, the route bus system 110-2 is capable of outputting the route bus video to the bus stop system 210 corresponding to the relay destination.

Configuring the system in the above-described manner makes it possible to output the video information taken by the route bus to the center 400 even if the narrow-band wireless system like the wireless LAN is used by request. It is thus possible to make it easy for a manager located in the center 400 to determine an increase in the route or the like.

### Third Embodiment

A third embodiment of the present invention will be explained.

The second embodiment has aimed to transmit the image photographed within each route bus to the center 400. On the other hand, the present embodiment aims to transmit an image obtained from a bus stop system 210-3 or an intersection system that conforms to a bus stop system, to the center 400 or route bus system 110-3.

The route bus system 110-3 according to the present embodiment is different from the second embodiment and needs not to provide the imaging device 117. Namely, the third embodiment becomes similar in configuration to the first embodiment. However, the provision of a display part becomes essential to the in-vehicle I/O unit 114. There is no difference in hardware at other than the above.

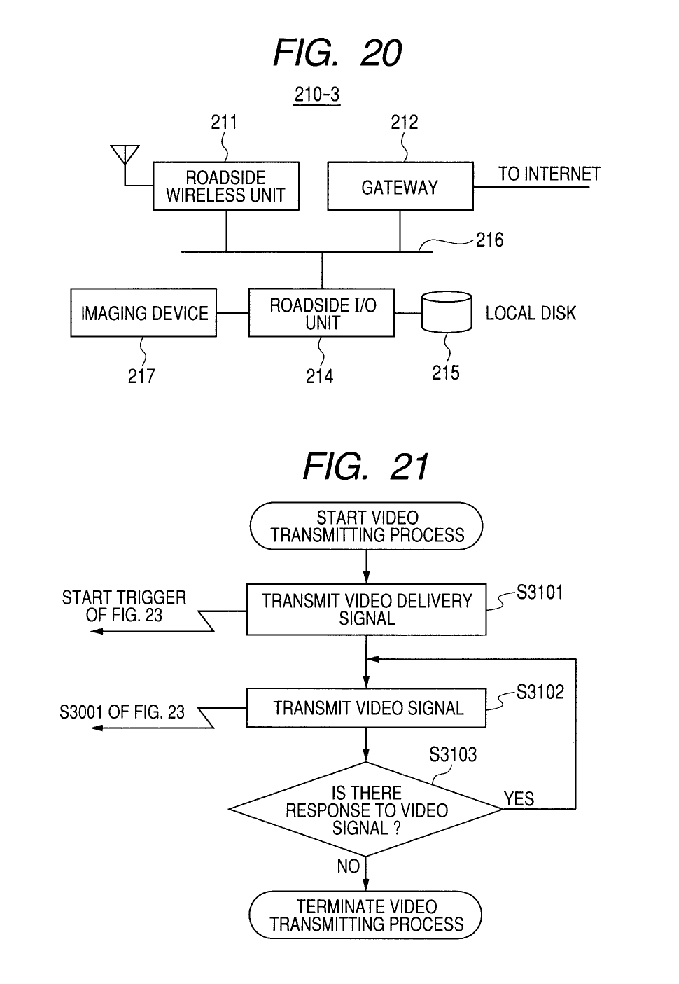

The bus stop system 210-3 will next be described. FIG. 20 is a block diagram of the bus stop system 210-3 according to the third embodiment of the present invention.

In a manner similar to the bus stop system 210 of the first embodiment, the bus stop system 210-3 has a roadside wireless unit 211, a gateway 212, a roadside I/O unit 214, a local disk 215 and a communication path 216. The feature of the bus stop system 210-3 resides in that an imaging device 217 is included in addition to the above.

The imaging device 217 is of an electronic device capable of imaging a motion picture or image according to the request from the roadside I/O unit 214. Although a solid-state image sensing device of a CMOS type or the like is assumed to be used in a manner similar to the imaging device 117, it is not particular about this.

Incidentally, the intersection system according to the present embodiment is intended to exclude user IF-associated equipment such as the display part from the roadside I/O unit 214 of the bus stop system 210-3. Since the vehicle approaches from three directions or four or more directions at the intersection, the number of imaging devices 117 and the amount of data on images to be transmitted tend to increase correspondingly. Substantial handling on the communication becomes similar to the bus stop system 210-3.

Incidentally, although there is a difference between targets for display, no difference in processing occurs even in the case of either the bus stop system or the intersection system. The following description will therefore be explained along the bus stop system 210-3.

Incidentally, IP addresses are assumed to be assigned those similar to those employed in the second embodiment.

A processing procedure of the present embodiment will next be described.

A link is placed between an in-vehicle wireless unit 112 of the route bus system 110-3 and its corresponding roadside wireless unit 211 of the bus stop system 210-3. This process is similar to FIG. 5 related to the first embodiment. At the stage of transmission of the bus ID notification signal at Step S1006, a private address is similarly established between the in-vehicle wireless unit 112 and the roadside wireless unit 211.

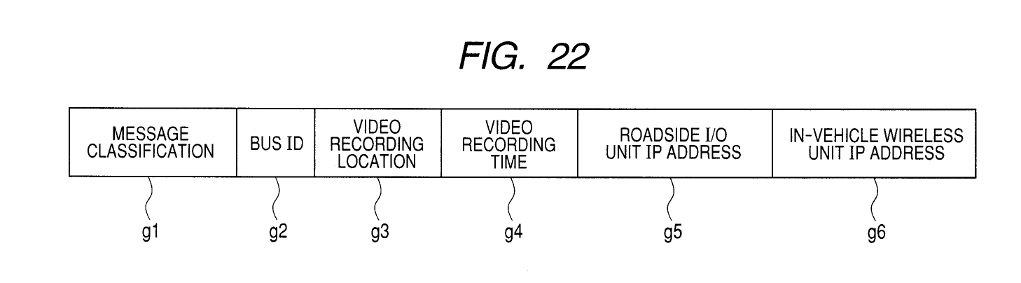

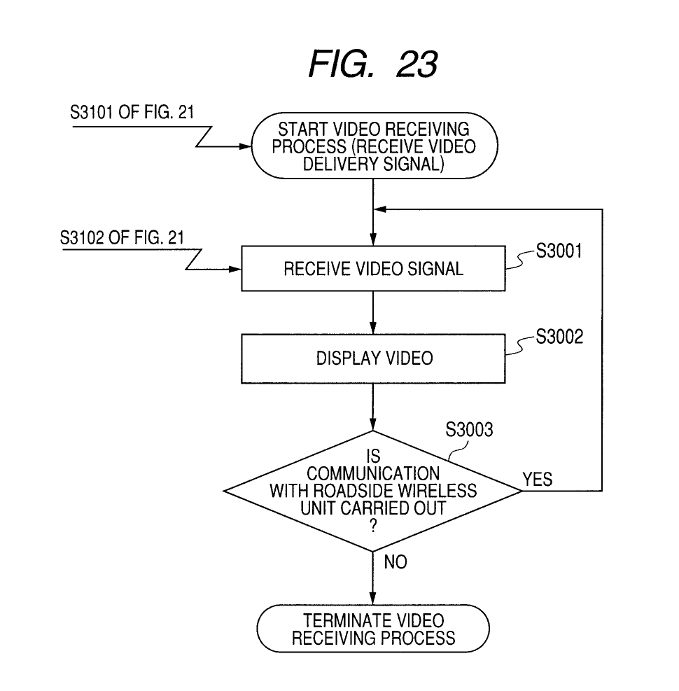

A video transmitting process of the bus stop system 210-3 will next be described. FIG. 21 is a flowchart showing the video transmitting process of the bus stop system 210-3 according to the third embodiment of the present invention.

The video transmitting process of the bus stop system 210-3 according to the present embodiment is started from the time when the roadside I/O unit 214 of the bus stop system 210-3 has received the bus ID notification signal (FIG. 7(b)) outputted at Step S1006 of FIG. 5.

When the roadside I/O unit 214 of the bus stop system 210-3 receives the bus ID notification signal, the roadside I/O unit 214 of the bus stop system 210-3 transmits a video delivery signal to the in-vehicle wireless unit 112 of the route bus system 110-3 (Step S3101).

FIG. 22 is a diagram showing one example of a data configuration of the video delivery signal. The video delivery signal includes a message classification field g1, a bus ID data field g2, a video recoding location g3, a video recording time g4, an IP address g5 for the roadside I/O unit, and an in-vehicle wireless unit IP address g6.

The message classification field g1 is of a data field indicative of what this signal means.

The bus ID data field g2 is of a data field for storing a bus ID allocated to the route bus system 110-3 which is a target for the need for video. Since video information to be transmitted is large, it can be used upon determining whether the video information is actually received by the in-vehicle wireless unit 112, but its actual application is a design matter.

The video recording location g3 is of a data field for storing a video recording place or the like therein. Although the establishment of the link and the allocation of the private address have been carried out at Step S1006 of FIG. 5 on a communication basis, there is no assurance at this time that information on a correspondence between each bus stop ID and an imaging location is transmitted. It is thus possible to transmit a bus location while a processing load on the route bus system 110-3 is being reduced, by transmitting the video recording location (name of bus stop system 210 or the like).

The video recording time g4 is of a data field indicative of a video imaging time.

The IP address g5 for the roadside I/O unit is of a data field for storing a private IP address for the roadside I/O unit 214. Here, “172. 16. 210. 1” is stored thereat.

The in-vehicle wireless unit IP address g6 stores therein a private IP address for the in-vehicle wireless unit 112 corresponding to a transmission destination. Here, “172. 10. 30. 1” is stored thereat.

A start trigger for a video receiving process is given to the route bus system 110-3 by transmitting the video delivery signal.

After the transmission of the video delivery signal, the roadside I/O unit 214 transmits a video signal obtained by the imaging device 117 according to the elapse of a predetermined time or the reception of a response signal (Step S3102). There are considered various timings each provided to complete this delivery of video information. There may be mentioned, for example, the stop of video transmission at the elapse of a predetermined time, etc. This has been described in the present drawing so as to be completed when there is no response from the in-vehicle wireless unit 112 of the route bus system 110-3 (Step S3103: No). While there is a response therefrom (Step S3103: Yes), the video transmission is continued.

FIG. 23 is a flowchart showing a video receiving process of the roadside wireless unit 211 according to the third embodiment of the present invention. It is a flowchart related to the video receiving process of the route bus system 110-3.

When it is confirmed by the bus ID data field g2 whether the video transmission signal sent from the roadside wireless unit 211 at Step S3101 of FIG. 21 is received and the video transmission signal is intended for itself, the video receiving process is started.

When the video receiving process is started, the in-vehicle I/O unit 114 executes the reception of the video transmission signal sent via the in-vehicle wireless unit 112 and communication path 115 (Step S3001) and the display of video by the display part (Step S3002).

During a period in which the video transmission signal is being continuously transmitted via the in-vehicle wireless unit 112, the in-vehicle I/O unit 114 performs the display of this video information (Step S3003: Yes). On the other hand, if it is not possible to perform the continuous reception of video information, then its display is terminated.

It is thus possible to perform confirmation of jam-up, etc. in advance by viewing visual images of the bus stop system 210-3 and the intersection system.

Incidentally, it is also considered that a plurality of images to be transmitted are contained upon communication with the intersection system. It is possible to obtain greater safety by adding a mechanism for switching between the images to the in-vehicle I/O unit 114.

### Fourth Embodiment

A fourth embodiment of the present invention will be explained.

The third embodiment aims to output the images of the bus stop system 210-3 or the intersection system to the roadside bus system 110-3. On the other hand, the present embodiment aims to allow a bus stop system or an intersection system to transmit a video signal to the center 400 in response to a request issued from the center 400. Incidentally, the configuration of the third embodiment is used as for the configuration of the bus stop system or the intersection system because the video transmission is carried out.

In the third embodiment, the bus stop system 210-3 or the like has performed the start of entire processing. On the other hand, the present embodiment is characterized in that the center 400 becomes a trigger for the entire processing.

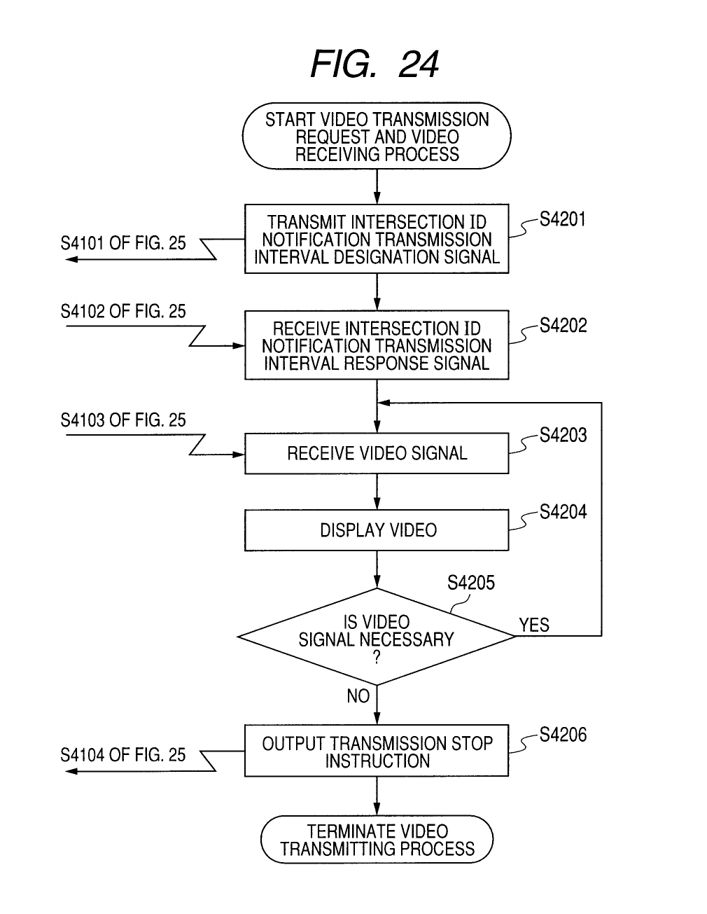

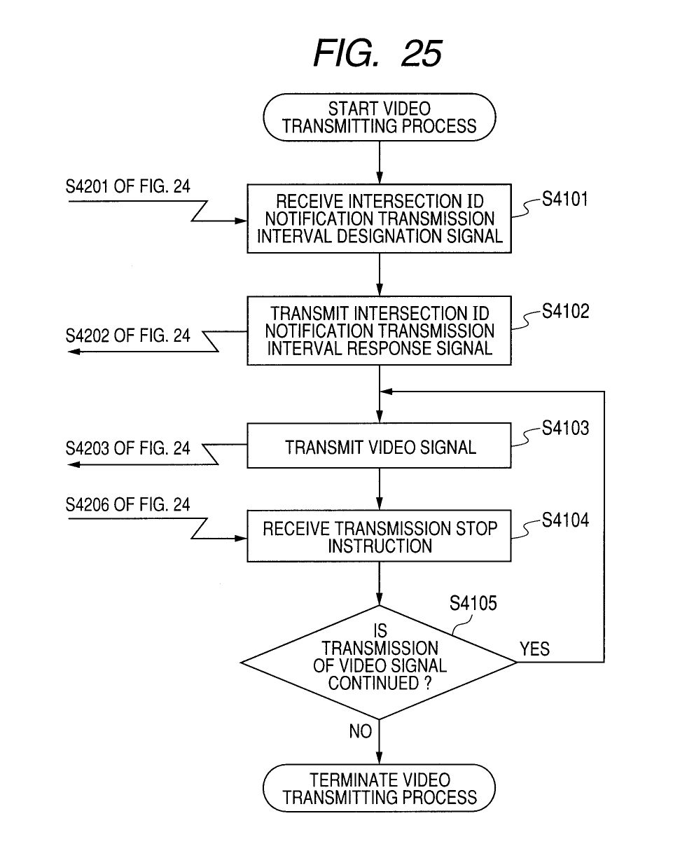

FIG. 24 is a flowchart showing a video transmission request and a video receiving process according to the fourth embodiment of the present invention.

When the images of the bus stop system or the like are required for the center 400, the center 400 starts the video transmission request and the video receiving process and outputs an intersection ID notification transmission interval designation signal to the bus stop system or the like (Step S4201). The transmission of the intersection ID notification transmission interval designation signal corresponds to 1) the setting of a beacon's notification interval to each bus stop system, corresponding to the operation of the center 400 of the first embodiment. It should be noted that although this is considered to be applied only to the intersection system on a signal nominal basis, it is applicable even to the bus stop system.

In the first embodiment, the center 400 did not expect a response as to whether or not the beacon's setting is done. On the other hand, in the present embodiment, the center 400 expects a response (intersection ID notification transmission interval response signal) from the corresponding bus stop system or the like (Step S4202). This response contains an intersection ID. This is thus because it is taken as the start of the video receiving process.

Thereafter, the reception (Step S4203) and display (Step S4204) of a video signal are performed. Since the term “video” is indicative of the contents expressed in motion pictures, the reception and display thereof are repeated (Step S4205: Yes) until the video becomes unnecessary (Step S4205: No).

On the other hand, if the video becomes unnecessary (Step S4205: No), then the center 400 outputs a transmission stop instruction to the corresponding bus stop system (Step S4206), and thereby the present process is terminated.

FIG. 25 is a flowchart related to a video transmitting process of the bus stop system according to the fourth embodiment of the present invention, which becomes paired with the center 400.

In the present embodiment as described above, the intersection ID notification transmission interval designation signal is outputted from the center 400 to the corresponding roadside I/O unit 214 of the bus stop system 210-3. At this time, there is a need to perform the putting substitution of a global IP address and a private IP address or the like. Since, however, the communication can preferably be established and it is of a design matter in the present embodiment, the details thereof will not be explained herein.

The roadside I/O unit 214 receives the intersection ID notification transmission interval designation signal therein and makes a change in beacon output timing of a roadside wireless unit 211 (Step S4101).

After the beacon output timing has been set and changed, the roadside wireless unit 211 of the bus stop system or the like outputs a response (intersection ID notification transmission interval response signal) for the intersection ID notification transmission interval designation signal to the center 400 (Step S4102).

Since the center 400 performs the process of receiving the video signal (Step S4203 of FIG. 24) after its transmission, the roadside I/O unit 214 performs the transmission of a video signal (Step S4103). At this time, the roadside I/O unit 214 acquires video data using the corresponding imaging device 217.

When the transmission stop instruction at Step S4206 of FIG. 24 is sent from the center (Step S4104), it is judged that there is no need to perform video transmission, and the processing of the video transmission signal is terminated. On the other hand, if the transmission stop instruction at Step S4206 of FIG. 24 is not sent therefrom, then the video transmission is executed consecutively (Step S4105: Yes).

As described above, the delivery of video from the bus stop system or the like can be performed on the center 400.

### Fifth Embodiment

A fifth embodiment of the present invention will be explained.

The present embodiment is assumed to transmit promotional ad video data from the center 400 to a route but system 110-5 running on business.

In a manner similar to the second embodiment even in the case of the present embodiment, the center 400 starts processing from the reception of a bus system coupling notification signal by the center 400 due to the transmission of the bus ID notification signal at Step S1006 of FIG. 5 (Step S1201 of FIG. 12).

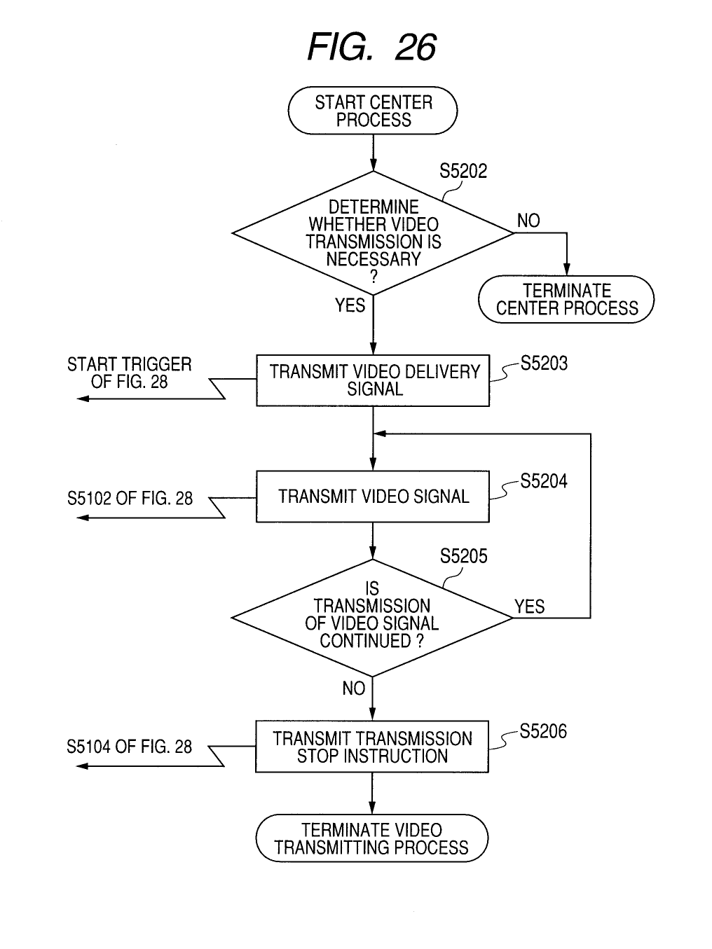

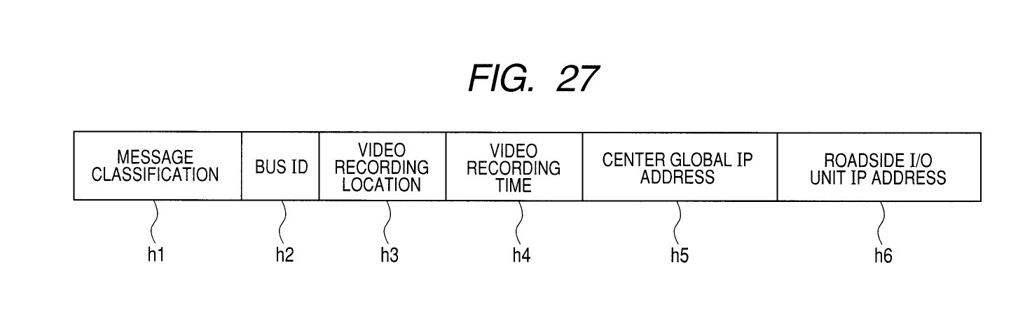

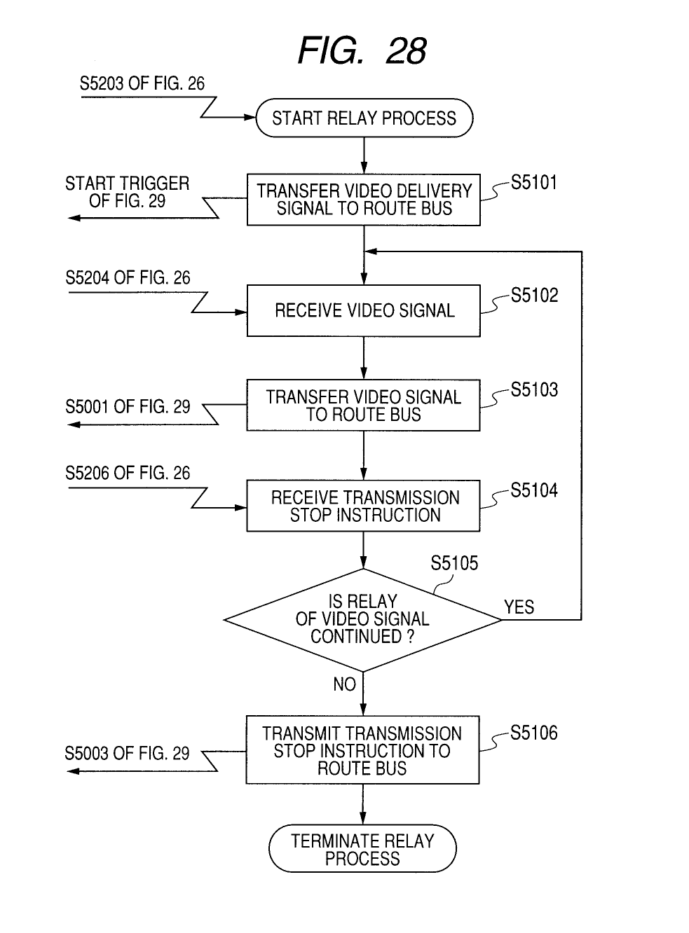

FIG. 26 is a flowchart showing a video transmitting process by the center 400 according to the fifth embodiment of the present invention. This process is started from the reception of the bus ID notification signal shown in FIG. 7(b) by the center 400, which signal is transferred at Step S2100 of FIG. 18.

If video transmission is not necessary (Step S5202: No), then the process is terminated thereat.

When the video transmission is necessary (Step S5202: Yes), a video delivery signal is transmitted to its corresponding roadside I/O unit 214 of each bus stop system (Step S5203). A relay process of the roadside I/O unit 214 is started in response to the reception of this signal. At this time, the video delivery signal assumes such a data configuration as shown in FIG. 27.

FIG. 27 is a diagram showing one example of a data configuration of a video delivery signal transmitted by the center 400 according to the fifth embodiment of the present invention. The video delivery signal includes a message classification field h1, a bus ID data field h2, a video recording location h3, a video recording time h4, a center global IP address h5, and an IP address h6 for each roadside I/O unit.

The message classification field h1 is of a data field indicative of what this signal means.

The bus ID data field h2 is of a data field for storing a bus ID allocated to the route bus system 110-5 which is target for video transmission. The value of the bus ID data field b2 of the received bus ID notification signal (FIG. 7(b)) is inputted as it is.

The video recoding location h3 is of a data field for storing a video recording place or the like therein.

The video recording time h4 is of a data field indicative of a video imaging time.

The center global IP address h5 is of a data field indicative of a global IP address allocated to the center communication unit 401 on the center side. A bus stop system relayed with the timing of S1201 of FIG. 12 has grasped it. Therefore, an IP address for the roadside I/O unit of this bus stop system is inputted to the data field.

The IP address h6 of the roadside I/O unit is of a data field for storing a private IP address for the roadside I/O unit 214 corresponding to a transmission destination. Here, “172. 16. 210. 1” is stored thereat.

Since the roadside I/O unit 214 starts the relay process as described above, the center 400 starts the transmission of a video signal (Step S5204). When the video signal to be transmitted continues to exist (Step S5205: Yes), the transmitting process of Step S5204 is continued.

If the video signal to be transmitted is found not to exist (Step S5205: No), the center 400 outputs a transmission stop designation signal (Step S5206) and thereby goes to the completion of the above process.

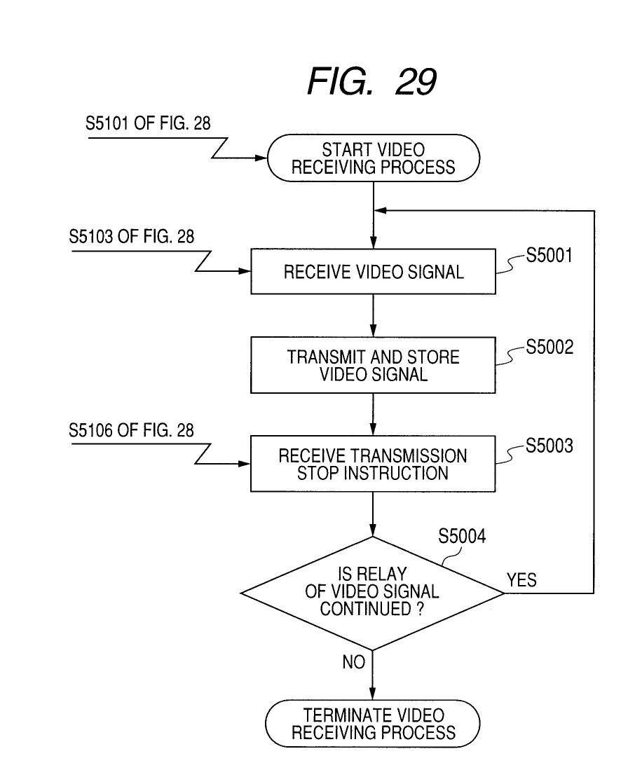

FIG. 28 is a flowchart showing the relay process of the roadside I/O unit 214 according to the fifth embodiment of the present invention, which is operated in response to the video delivery signal transmitted from the center 400 at Step S5203. The process of the roadside I/O unit 214 will be described using the flowchart.

Referring to the bus ID data field h2 for the transmitted video delivery signal, a route bus system target for signal transmission is specified. If its route bus still exists within the corresponding access point area of the roadside wireless unit 211 of the bus stop system after the route bus system has been specified, then the video delivery signal is transmitted to its corresponding in-vehicle wireless unit 112 of the route bus system (Step S5101).

If the video delivery signal can be transmitted without errors, then the video signal transmitted from the center 400 at Step S5204 of FIG. 26 is received (Step S5102). The received video information is outputted to the in-vehicle wireless unit 112 of the route bus system to which the video delivery signal has been transmitted at Step S5101 (Step S5103).

The reception transfer process at Steps S5102 and S5103 is continued while the video information is being transmitted. This is continued as long as the transmission stop instruction explicitly shown at Step S5206 of FIG. 26 or until a link to a route bus system corresponding to a transfer destination is cut off.

If the transfer of the video information is unrequired/disabled (Step S5105: No) where, for example, the transmission stop instruction explicitly shown at Step S5206 of FIG. 26 is received (Step S5104), the center 400 outputs a transmission stop instruction to the corresponding route bus (Step S5106) and thereby goes to the completion of the relay process.

A video signal receiving process on the route bus system will finally be described. FIG. 29 is a flowchart related to the video signal receiving process according to the fifth embodiment of the present invention.

The video signal receiving process is done assuming the transmission of the video delivery signal to the in-vehicle wireless unit 112 at Step S5101 of FIG. 28 as a start trigger.

After the startup of the video signal receiving process, the video signal outputted to the in-vehicle wireless unit 112 of each route bus at Step S5103 of FIG. 28 is received (Step S5001). The received video signal is transmitted to the in-vehicle I/O unit 114 via the communication path 115. The in-vehicle I/O unit 114 stores the video signal in a hard disk contained in itself (Step S5002).

When during the reception of the video signal, the transmission stop instruction outputted at Step S5106 of FIG. 28 is received (Step S5003) or the link to the bus stop system is cut off (Step S5004: No), the video signal receiving process is halted.

While the video signal is being transmitted (Step S5004: Yes), the reception and storage at Steps S5001 and S5002 are continued.

Incidentally, there exists one containing a plurality of video information as the stored video information. Whether any of these should be displayed on the display part of the in-vehicle I/O unit 114 with any timing (for example, a section in which immediately after the reception of the video information, bus stop-to-bus stop communications at the wireless communication unit 401 are being cut off), is a design matter. A function such as video processing (insertion of an advertising telop) may be provided upon its display.

While the invention made above by the present inventors has been described specifically on the basis of the preferred embodiments, the present invention is not limited to the embodiments referred to above. It is needless to say that various changes can be made thereto within the scope not departing from the gist thereof.

The embodiments in which the present invention is applied to the traffic management system according to the services of each route bus have been described above. The present invention is however not limited to the embodiments, but applicable even to a traffic system having an exclusive guideway such as a railway (including a subway), a streetcar or the like, a deliver system by a commercial freight car run with an assumption of only operation on a predetermined route, etc.

What is claimed is:

1. A bus location indicating method suitable for use in a traffic system comprising a route bus system installed in each of route buses, a bus stop system having a display part, and a center system coupled to the bus stop system via a network, said method comprising the steps of:
allowing the bus stop system to periodically output a bus stop ID notification signal;
allowing the route bus system to receive the bus stop ID notification signal and allowing the route bus system to output a bus ID notification signal added with both a bus ID added to the bus stop ID notification signal and a bus stop ID allocated to each bus stop to the bus stop system;
allowing the bus stop system to output a bus system coupling notification signal added with the bus ID and the bus stop ID to the center system;
generating bus location update data using the bus ID and the bus stop ID;
allowing the center system to determine a transmission destination for the bus location update data using the bus ID;
allowing the center system to transmit the bus location update data to the transmission destination determined at the transmission destination determining step; and
allowing the bus stop system to display location information of the route bus having the route bus system over the display part using the bus location update data.

2. A bus location indicating method suitable for use in a traffic system comprising a route bus system installed in each of route buses, a bus stop system having a display part, and a center system coupled to the bus stop system via a network, said method comprising the steps of:
allowing the bus stop system to periodically output a bus stop ID notification signal;
allowing the route bus system to receive the bus stop ID notification signal and allowing the route bus system to output a bus ID notification signal added with both a bus ID added to the bus stop ID notification signal and a bus stop ID allocated to the bus stop system to the bus stop system;
receiving the bus ID notification signal outputted at the bus ID notification signal output step to thereby start a timer;
allowing the bus stop system to output a bus system coupling release notification signal added with the bus ID and the bus stop ID allocated to the bus stop system when a count of the timer is expired;
allowing the center system to generate bus location update data using the bus stop ID and the bus ID added to the bus system coupling release notification signal;
allowing the center system to determine a transmission destination for the bus location update data using the bus ID;
allowing the center system to transmit the bus location update data to the transmission destination determined at the transmission destination determining step; and
allowing the bus stop system to display location information of the route bus having the route bus system over the display part using the bus location update data.

3. A bus video acquiring method suitable for use in a traffic system comprising a route bus system installed in each of route buses, a bus stop system, and a center system having a display part and coupled to the bus stop system via a network, said route bus system having an imaging device for acquiring video, said method comprising the steps of:
allowing the bus stop system to periodically output a bus stop ID notification signal;
allowing the route bus system to receive the bus stop ID notification signal and allowing the route bus system to output a bus ID notification signal added with both a bus ID added to the bus stop ID notification signal and a bus stop ID allocated to the bus stop system to the bus stop system;
allowing the bus stop system to transfer the bus ID notification signal to the center system;
allowing the center system requiring video information to output a route bus vide transmission request signal for the route bus system to the bus stop system on the basis of the bus ID and the bus stop ID in response to the transferred bus ID notification signal;
allowing the bus stop system to transfer the route bus video transmission request signal to the route bus system having the bus ID;
allowing the route bus system having received the route bus video transmission request signal therein to output video information acquired by the imaging device to the bus stop system; and
allowing the bus stop system having received the video information therein to transfer the video information to the center system.

4. An intersection video acquiring method suitable for use in a traffic system comprising a route bus system having a display part, which is installed in each of route buses, and an intersection system having an imaging device for acquiring video, said method comprising the steps of:
allowing the intersection system to periodically output an intersection ID notification signal;
allowing the route bus system to receive the intersection ID notification signal therein and allowing the route bus system to output a bus ID notification signal to the intersection system;
allowing the intersection system having received the bus ID notification signal therein to output a video delivery signal for causing the route bus system to start a process for receiving a video signal to the route bus system;
allowing the route bus system having received the video delivery signal therein to start the video signal receiving process;
transmitting the video signal to the route bus system after the video delivery signal output step; and
allowing the route bus system having received the video signal therein to display the video signal over the display part.

5. An intersection video acquiring method suitable for use in a traffic system comprising an intersection system having an imaging device for acquiring video, and a center system having a display part and coupled to the intersection system via a network, said method comprising the steps of:
allowing the center system to output an intersection ID notification transmission interval designation signal for causing the intersection system to set a cycle at which an intersection ID notification signal is outputted;
allowing the intersection system having received the intersection ID notification transmission interval designation signal therein to output the intersection ID notification signal for causing the center system to start a video receiving process;
allowing the intersection system to output a video signal to the center system after the intersection ID notification signal output step; and
outputting the video signal received by the center system to the display part.

6. A video delivery method suitable for use in a traffic system comprising a route bus system installed in each of route buses, a bus stop system, and a center system coupled to the bus stop system via a network, said method comprising the steps of:
allowing the center system to output a video delivery signal added with a bus ID to the bus stop system in order to execute a process for relaying a video signal;
allowing the bus stop system to start a relay process in response to the video delivery signal and allowing the bus stop system to transfer the video delivery signal to the route bus system having the bus ID in order to start a process for receiving the video signal;
allowing the route bus system to start a video receiving process in response to the transfer of the video delivery signal;
transmitting the video signal to the bus stop system after the video delivery signal transmitting step; and
allowing the bus stop system to transfer the video signal to the route bus system.
